(19) United States
(12) Patent Application Publication
(10) Pub. No.: US 2007/0067585 A1
(43) Pub. Date: Mar. 22, 2007

(54) Snapshot maintenance apparatus and method

(76) Inventors: Naoto Ueda, Yokohama (JP); Naohiro Fujii, Yokohama (JP); Koji Honami, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/282,707

(22) Filed: Nov. 21, 2005

(30) Foreign Application Priority Data
Sep. 21, 2005 (JP) 2005-274125

(51) Int. Cl. G06F 12/16

(52) U.S. Cl. 711/162

(57) ABSTRACT

Provided is a snapshot maintenance apparatus and method capable of maintaining a snapshot in a highly reliability manner. In a snapshot maintenance apparatus and method for maintaining an image at the time of creating a snapshot of an operation volume for reading and writing data from and to a host system, a difference volume and a failure-situation volume are set in a connected physical device; and difference data, which is the difference formed from the operation volume at the time of creating the snapshot and the current operation volume, is sequentially saved in the difference volume according to the writing of the data from the host system in the operation volume, and the difference data is saved in the failure-situation volume when a failure occurs in the difference volume.

### BACKGROUND

1. Field of the Invention

The present invention relates to a snapshot maintenance apparatus and method, and for instance is suitably employed in a disk array device.

2. Description of the Related Art

Conventionally, as one function of a NAS (Network Attached Storage) server and disk array device, there is a so-called snapshot function for retaining an image of an operation volume (a logical volume for the user to read and write data) designated at the time when a snapshot creation order is received. A snapshot function is used for restoring the operation volume at the time such snapshot was created when data is lost due to man-caused errors or when restoring the operation volume to a state of a file system at a desired time.

The image (also referred to as a virtual volume) of the operation volume to be retained by the snapshot function is not the data of the overall operation volume at the time of receiving the snapshot creation order, but is rather configured from the data of the current operation volume, and the difference data which is the difference between the operation volume at the time of receiving the snapshot creation order and the current operation volume. And the status of the operation volume at the time such snapshot creation order was given is restored based on the foregoing difference volume and current operation volume. Therefore, according to the snapshot function, in comparison to a case of storing the entire operation volume as is, there is an advantage in that an image of the operation volume at the time a snapshot creation order was given can be maintained with a smaller storage capacity.

Further, in recent years, a method of maintaining a plurality of generations of snapshots has been proposed (c.f. Japanese Patent Laid-Open Publication No. 2004-342050; hereinafter “Patent Document 1”). For instance, Patent Document 1 proposes the management of a plurality of generations of snapshots with a snapshot management table which associates the respective blocks of an operation volume and the blocks of the difference volume storing difference data of the snapshots of the respective generations.

### SUMMARY

However, according to the maintenance method of a plurality of generations of snapshots disclosed in Patent Document 1, when a failure occurs in the difference volume, there is a problem in that the system cannot be ongoingly operated unless the snapshots of the respective generations acquired theretofore are abandoned.

Nevertheless, the failure in a difference volume could be an intermittent failure or an easily-recoverable failure. The loss would be significant if the snapshots of all generations must be abandoned for the ongoing operation of the system even for brief failures. Therefore, if a scheme for maintaining the snapshot even when a failure occurs in the difference volume can be created, it is considered that the reliability of the disk array device can be improved.

The present invention was devised in view of the foregoing points, and an object thereof is to propose a snapshot maintenance apparatus and method capable of maintaining a snapshot in a highly reliable manner.

In order to achieve the foregoing object, the present invention provides a snapshot maintenance apparatus for maintaining an image at the time of creating a snapshot of an operation volume for reading and writing data from and to a host system, including: a volume setting unit for setting a difference volume and a failure-situation volume in a connected physical device; and a snapshot management unit for sequentially saving difference data, which is the difference formed from the operation volume at the time of creating the snapshot and the current operation volume, in the difference volume according to the writing of the data from the host system in the operation volume, and saving the difference data in the failure-situation volume when a failure occurs in the difference volume.

As a result, with this snapshot maintenance apparatus, even when a failure occurs in the difference volume, the difference data during the period from the occurrence of such failure to the recovery thereof can be retained in the failure-situation volume and, therefore, the system can be ongoingly operated while maintaining the snapshot.

Further, the present invention also provides a snapshot maintenance method for maintaining an image at the time of creating a snapshot of an operation volume for reading and writing data from and to a host system, including: a first step of setting a difference volume and a failure-situation volume in a connected physical device; and a second step of sequentially saving difference data, which is the difference formed from the operation volume at the time of creating the snapshot and the current operation volume, in the difference volume according to the writing of the data from the host system in the operation volume, and saving the difference data in the failure-situation volume when a failure occurs in the difference volume.

As a result, according to this snapshot maintenance method, even when a failure occurs in the difference volume, the difference data during the period from the occurrence of such failure to the recovery thereof can be retained in the failure-situation volume and, therefore, the system can be ongoingly operated while maintaining the snapshot.

According to the present invention, a snapshot maintenance apparatus and method capable of maintaining the snapshot in a highly reliability manner can be realized.

### DESCRIPTION OF DRAWINGS

FIG. 1 is a block diagram for explaining the snapshot function in a basic NAS server;

FIG. 2 is a conceptual diagram for explaining a snapshot management table;

FIG. 3 is a conceptual diagram for explaining basic snapshot creation processing;

FIG. 4 is a conceptual diagram for explaining basic snapshot creation processing;

FIG. 5 is a conceptual diagram for explaining basic snapshot creation processing;

FIG. 6 is a conceptual diagram for explaining basic snapshot creation processing;

FIG. 7 is a conceptual diagram for explaining basic snapshot creation processing;

FIG. 8 is a conceptual diagram for explaining basic snapshot creation processing;

FIG. 9 is a conceptual diagram for explaining basic snapshot creation processing;

FIG. 10 is a conceptual diagram for explaining basic snapshot creation processing;

FIG. 11 is a conceptual diagram for explaining basic snapshot creation processing;

FIG. 12 is a conceptual diagram for explaining basic snapshot creation processing;

FIG. 13 is a conceptual diagram for explaining basic snapshot creation processing;

FIG. 14 is a conceptual diagram for explaining basic snapshot creation processing;

FIG. 15 is a conceptual diagram for explaining basic snapshot creation processing;

FIG. 16 is a conceptual diagram for explaining basic snapshot creation processing;

FIG. 17 is a conceptual diagram for explaining basic snapshot creation processing;

FIG. 18 is a conceptual diagram for explaining basic snapshot data read processing;

FIG. 19 is a conceptual diagram for explaining basic snapshot data read processing;

FIG. 20 is a conceptual diagram for explaining basic snapshot data read processing;

FIG. 21 is a conceptual diagram for explaining basic snapshot data read processing;

FIG. 22 is a conceptual diagram for explaining basic snapshot data read processing;

FIG. 23 is a conceptual diagram for explaining basic snapshot data read processing;

FIG. 24 is a conceptual diagram for explaining the problems of a basic snapshot function;

FIG. 25 is a conceptual diagram for explaining the problems of a basic snapshot function;

FIG. 26 is a block diagram for explaining the snapshot function according to the present embodiment;

FIG. 27 is a conceptual diagram for explaining the snapshot function according to the present embodiment;

FIG. 28 is a conceptual diagram for explaining the snapshot function according to the present embodiment;

FIG. 29 is a block diagram showing the configuration of a network system according to the present embodiment;

FIG. 30 is a conceptual diagram showing the schematic configuration of a snapshot program;

FIG. 31 is a conceptual diagram for explaining the snapshot function according to the present embodiment;

FIG. 32 is a conceptual diagram for explaining the snapshot function according to the present embodiment;

FIG. 33 is a flowchart for explaining write processing of user data;

FIG. 34 is a flowchart for explaining switching processing;

FIG. 35 is a conceptual diagram for explaining switching processing;

FIG. 36 is a flowchart for explaining snapshot data read processing;

FIG. 37 is a flowchart for explaining snapshot creation processing;

FIG. 38 is a flowchart for explaining snapshot deletion processing;

FIG. 39 is a flowchart for explaining difference data recovery processing;

FIG. 40 is a conceptual diagram for explaining difference data recovery processing;

FIG. 41 is a conceptual diagram for explaining difference data recovery processing;

FIG. 42 is a conceptual diagram for explaining difference data recovery processing;

FIG. 43 is a conceptual diagram for explaining difference data recovery processing;

FIG. 44 is a conceptual diagram for explaining difference data recovery processing;

FIG. 45 is a conceptual diagram for explaining difference data recovery processing;

FIG. 46 is a conceptual diagram for explaining difference data recovery processing;

FIG. 47 is a conceptual diagram for explaining difference data recovery processing;

FIG. 48 is a conceptual diagram for explaining difference data recovery processing;

FIG. 49 is a conceptual diagram for explaining difference data recovery processing;

FIG. 50 is a conceptual diagram for explaining difference data recovery processing; and

FIG. 51 is a conceptual diagram for explaining difference data recovery processing.

### DETAILED DESCRIPTION

An embodiment of the present invention is now explained in detail with reference to the attached drawings.

### (1) Basic Snapshot Function in NAS Server

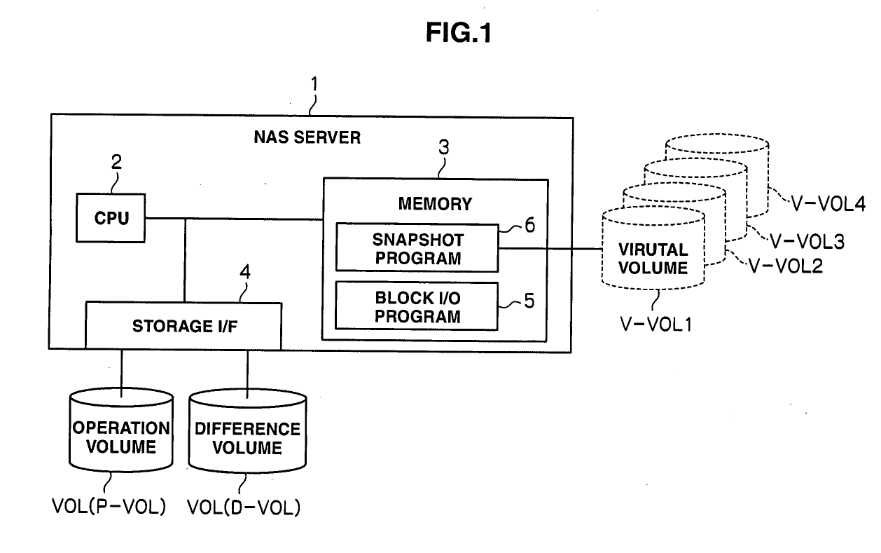

FIG. 1 shows an example of the schematic configuration of a basic NAS server 1. This NAS server 1 is configured by being equipped with a CPU (Central Processing Unit) 2 for governing the operation and control of the entire NAS server 1, a memory 3, and a storage interface 4.

A storage device (not shown) such as a hard disk drive is connected to the storage interface 4, and logical volumes VOL are defined in a storage area provided by such storage device. User data subject to writing transmitted from a host system as a higher-level device (not shown) is stored in the logical volume VOL defined as an operation volume P-VOL among the logical volumes VOL defined as described above.

Various programs such as a block I/O program 5 and a snapshot program 6 are stored in the memory 3. The CPU 2 controls the input and output of data between the host system and operation volume P-VOL according to the block I/O program 5. Further, the CPU 2 defines a difference volume D-VOL in relation to the operation volume P-VOL according to the snapshot program 6, and saves the difference data obtained at the time of creating the snapshot in the difference volume D-VOL. Meanwhile, the CPU 2 also creates a plurality of generations of snapshots (virtual volumes V-VOL 1, V-VOL 2, . . . ) based on the difference data stored in the difference volume D-VOL and the user data stored in the operation volume.

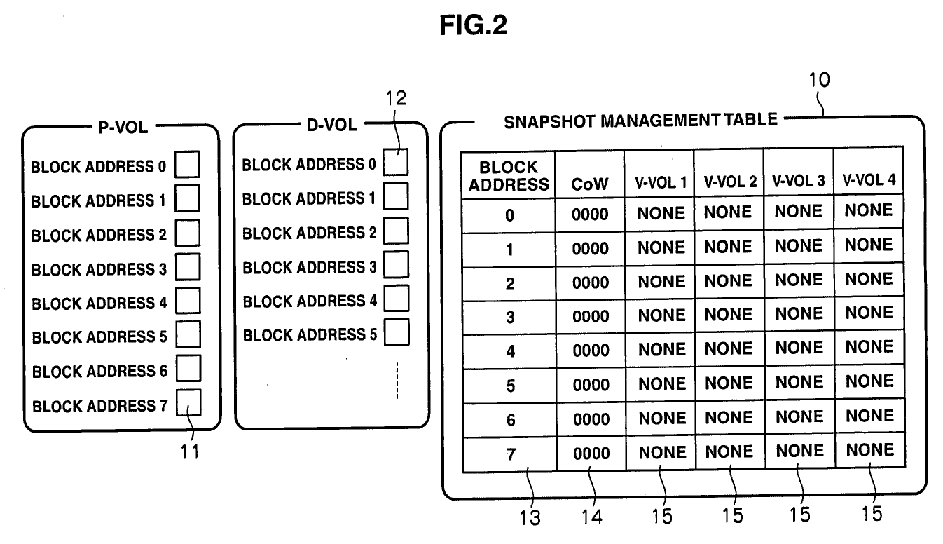

Next, the basic snapshot function in the NAS server 1 is explained in detail. FIG. 2 shows a snapshot management table 10 for managing a plurality of generations of snapshots created by the CPU 2 in the memory 3 according to the snapshot program 6. In the example of FIG. 2, for ease of understanding the explanation, the storage area of the operation volume P-VOL is configured from eight blocks 11, and the storage area of the difference volume D-VOL is configured from infinite blocks 12. Further, the number of generations of snapshots that can be created is set to four generations.

As shown in FIG. 2, the snapshot management table 10 is provided with a block address column 13, a Copy-on-Write bitmap column (hereinafter referred to as a “CoW bitmap column”) 14 and a plurality of save destination block address columns 15 corresponding respectively to each block 11 of the operation volume P-VOL.

Each block address column 13 stores block addresses (“0” to “7”) of the blocks 11 corresponding to the respective operation volumes P-VOL. Further, each CoW bitmap column 14 stores a bit string (hereinafter referred to as a CoW bitmap) having the same number of bits as the number of generations of the snapshots that can be created. Each bit of this CoW bitmap corresponds to the respective snapshots of the first to fourth generations in order from the far left, and these are all set to “0” at the initial stage when no snapshot has been created.

Meanwhile, four save destination block address columns 15 are provided to each block 11 of the operation volume P-VOL. These save destination block address columns 62 are respectively associated with the first to fourth generation snapshots. In FIG. 2, “V-VOL 1” to “V-VOL 4” are respectively associated with the first to fourth generation snapshots.

Each save destination block address column 62 stores block addresses of the blocks in the difference volume D-VOL saving the difference data of the snapshot generation of the corresponding blocks 11 in the operation volume P-VOL (blocks 11 of the block addresses stored in the corresponding block address column 13). However, when the difference data of the snapshot generation of the corresponding blocks 11 in the operation volume P-VOL has not yet been saved; that is, when the user data has not yet been written in the blocks 11 in the snapshot generation thereof, a code of “None” representing that there is no block address of the corresponding save destination is stored.

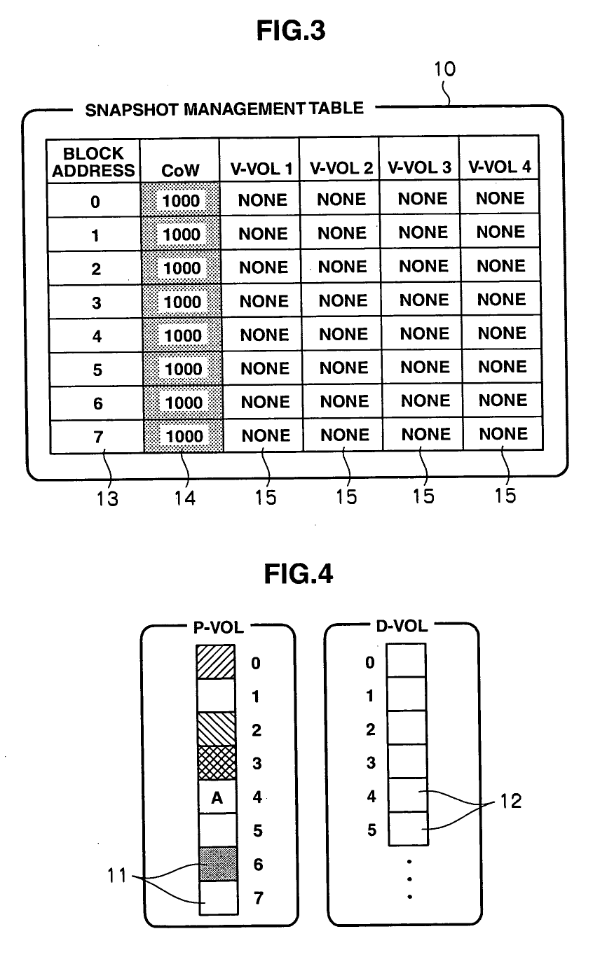

And, when the CPU 2 is given a creation order of the first generation snapshot from the host system when the snapshot management table 10 is in the initial state illustrated in FIG. 2, a shown in FIG. 3, the CPU 2 foremost updates the bit at the far left associated with the first generation snapshot to “1” regarding all CoW bitmaps respectively stored in each CoW bitmap column 14 of the snapshot management table 10. If the bit of the CoW bitmap is “1” as described above, this means that when user data is written in the corresponding block 11 in the operation volume P-VOL, the data in this block 11 immediately before such writing should be saved as difference data in the difference volume D-VOL. The CPU 2 thereafter waits for the write request of user data in the operation volume P-VOL to be given from the host system.

Incidentally, status of the operation volume P-VOL and the difference volume D-VOL in the foregoing case is depicted in FIG. 4. Here, let it be assumed that user data has been written in the respective blocks 11 in which the block addresses of the operation volume P-VOL are “1”, “3” to “5” and “7”. Further, immediately after a snapshot creation order is given from the host system to the NAS server 1, since user data has not yet been written in any block 11 of the operation volume P-VOL, let it be assumed that difference data has not yet been written in the difference volume D-VOL.

Thereafter, for instance, as shown in FIG. 5, when a write request of user data in the respective blocks 11 in which the block addresses in the operation volume P-VOL are “4” and “5” is given from the host system, the CPU 2 foremost confirms the value of the corresponding bit of the corresponding CoW bitmap in the snapshot management table 10 according to the snapshot program 6 (FIG. 1). Specifically, the CPU 2 will confirm the value of the bit at the far left associated with the first generation snapshot among the respective CoW bitmaps associated with the blocks 11 in which the block address in the snapshot management table 10 is “4” or “5”.

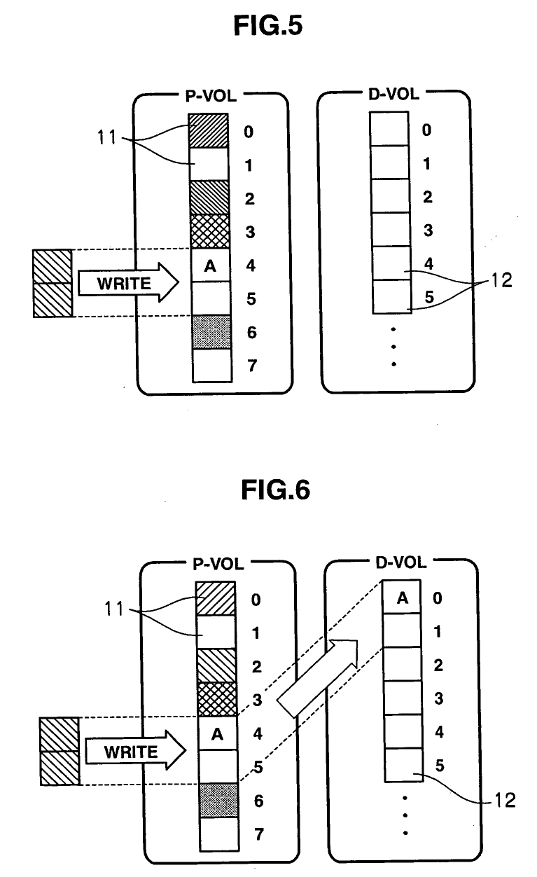

And, when the CPU 2 confirms that the value of the bit is “1”, as shown in FIG. 6, it foremost saves, as difference data, the user data stored in the respective blocks 11 in which the block address in the operation volume P-VOL is “4” or “5” in a block 12 (in the example of FIG. 6, the block 12 where the block address is “0” or “1”) available in the difference volume D-VOL.

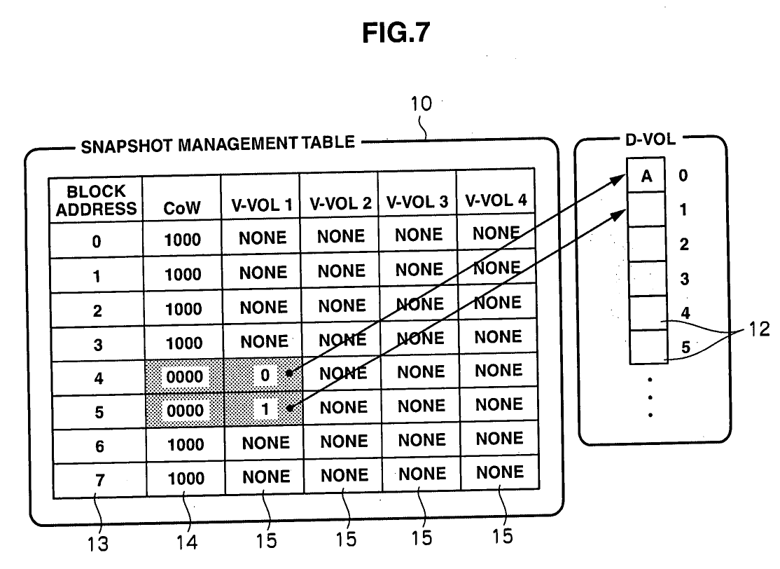

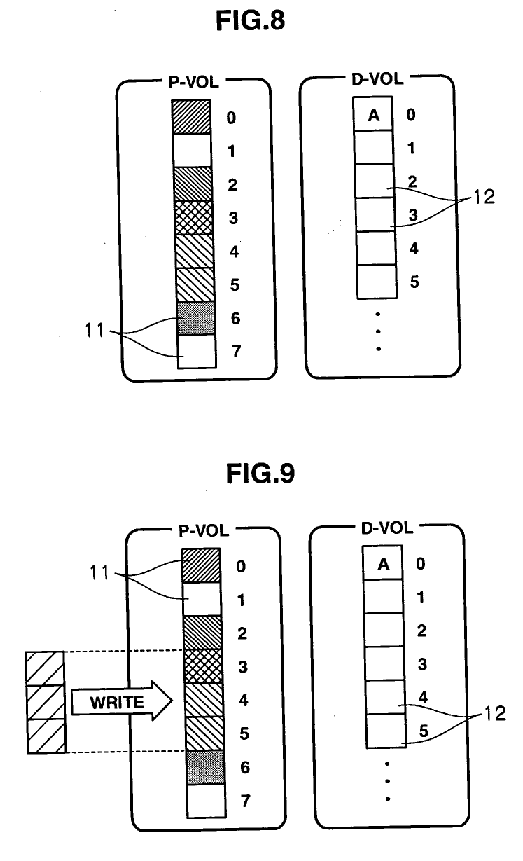

In addition, as shown in FIG. 7, the CPU 2 returns the bit at the far left of each of the corresponding CoW bitmap columns (respective CoW bitmap columns colored in FIG. 7) in the snapshot management table 10 to “0”. Meanwhile, the CPU 2 also stores the block address (“0” or “1” in this example) of the blocks 12 in the difference volume D-VOL storing each of the corresponding difference data in each of the corresponding save destination block address columns 62 (respective save destination block address columns 62 colored in FIG. 7) corresponding to the “V-VOL 1” row in the snapshot management table 10. And, when the update of this snapshot management table 10 is complete, the CPU 2 writes the user data in the operation volume P-VOL. Status of the operation volume P-VOL and difference volume D-VOL after the completion of write processing of user data is shown in FIG. 8.

Further, as shown in FIG. 9 later, when the write request of user data in the respective blocks 11 in which the block addresses of the operation volume P-VOL are “3” to “5” is given from the host system, the CPU 2 refers to the snapshot management table 10, and confirms the value of the bit at the far left corresponding to the current snapshot in the respective CoW bitmaps associated with the respective blocks 11. Here, since the bit at the far left of the CoW bitmap associated with the respective blocks 11 in which the block address is “4” or “5” has already been cleared to “0” (returned to “0”), the only block 11 in the operation volume P-VOL to save the difference data is the block 11 having a block address of “3”.

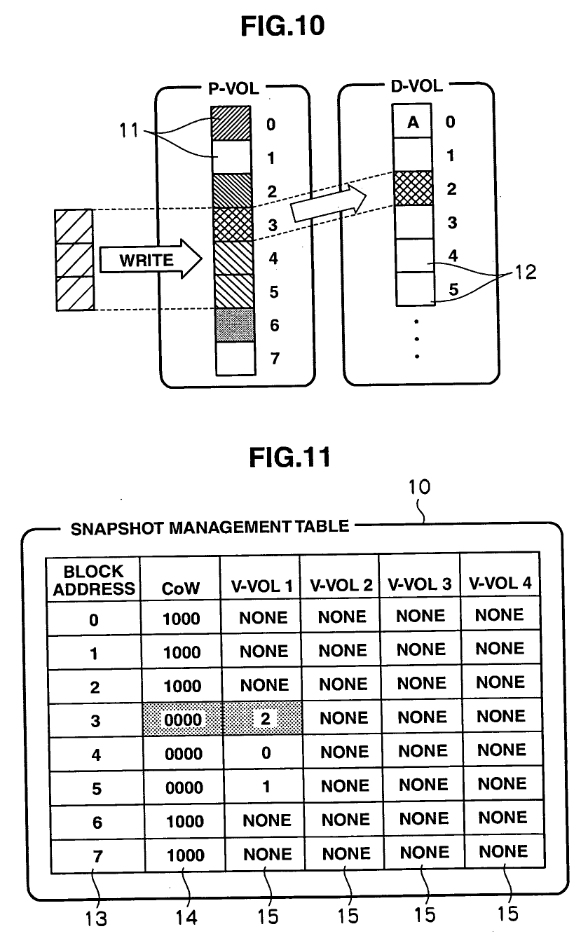

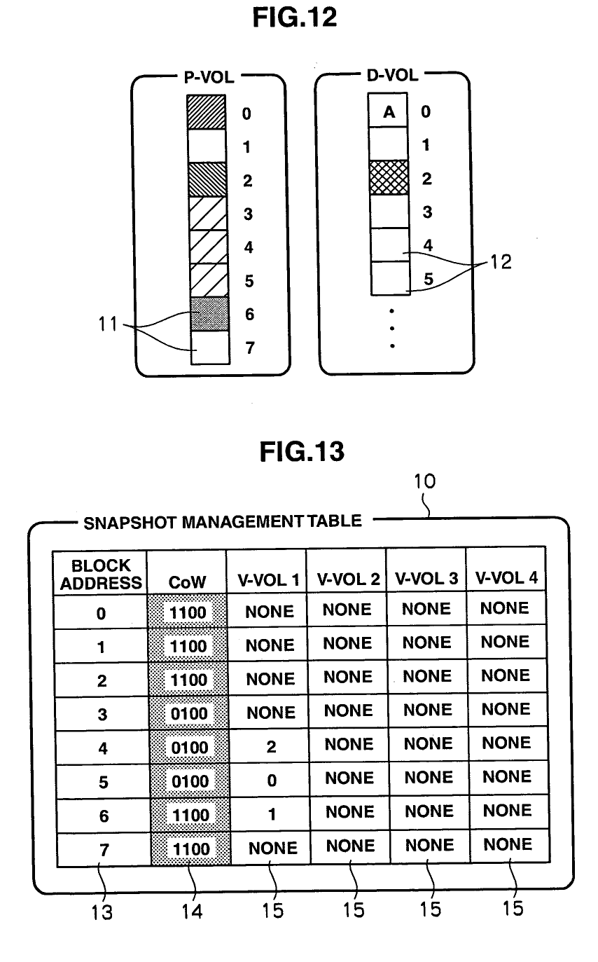

Thus, here, as shown in FIG. 10, the CPU 2 saves, as difference data, the user data stored in the block 11 having a block address of “3” in the operation volume P-VOL in the block 12 (block 12 having a block address of “2” in the example of FIG. 10) available in the difference volume D-VOL. Further, as shown in FIG. 11 later, the CPU 2 stores the block address (“2” in this example) of the block 12 in the difference volume D-VOL saving the difference data in each of the save destination block address columns 15 (respective save destination block address columns 15 colored in FIG. 11) corresponding to the “V-VOL 1” row in the snapshot management table 10. And, when the update of this snapshot management table 10 is complete, the CPU 2 writes the user data in the operation volume P-VOL. Status of the operation volume P-VOL and difference volume D-VOL after the completion of write processing of user data is shown in FIG. 12.

Meanwhile, when a snapshot creation order for the next generation (second generation) is thereafter given from the host system, a shown in FIG. 13, the CPU 2 foremost changes the second bit from the far left associated with the second generation snapshot in the respective CoW bitmaps stored in the respective CoW bitmap columns 14 of the snapshot management table 10 to “1”.

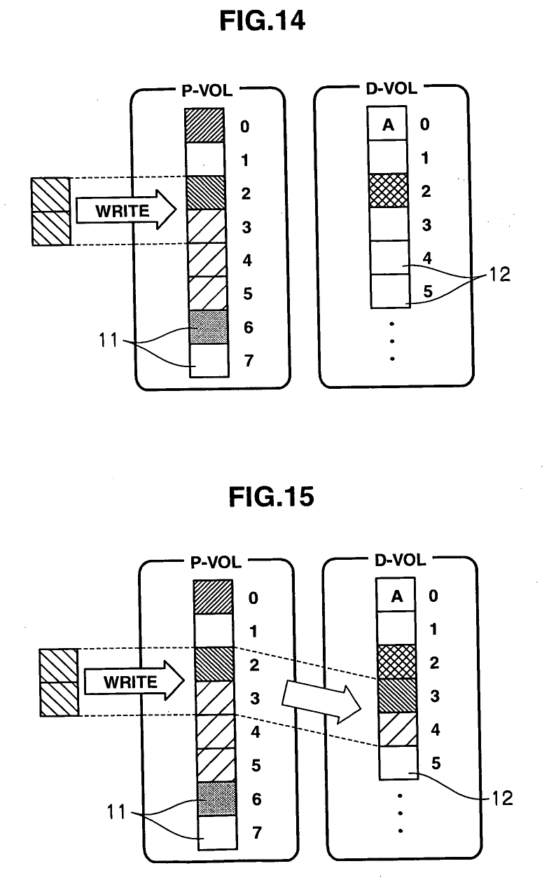

Thereafter, as shown in FIG. 14, when a write request of user data in the respective blocks 11 in which the block address of the operation volume P-VOL is “2” or “3” is given from the host system, the CPU 2 foremost confirms the value of the second bit from the far left associated with the second generation snapshot in the respective CoW bitmaps in the snapshot management table 10 corresponding to these blocks 11. Here, since every bit value is “1”, as shown in FIG. 15, the CPU 2 saves, as difference data, the respective data stored in the respective blocks 11 in which the block address of the operation volume P-VOL is “2” or “3” in the block 12 (block 12 having a block address of “3” or “4” in the example of FIG. 15) available in the difference volume D-VOL.

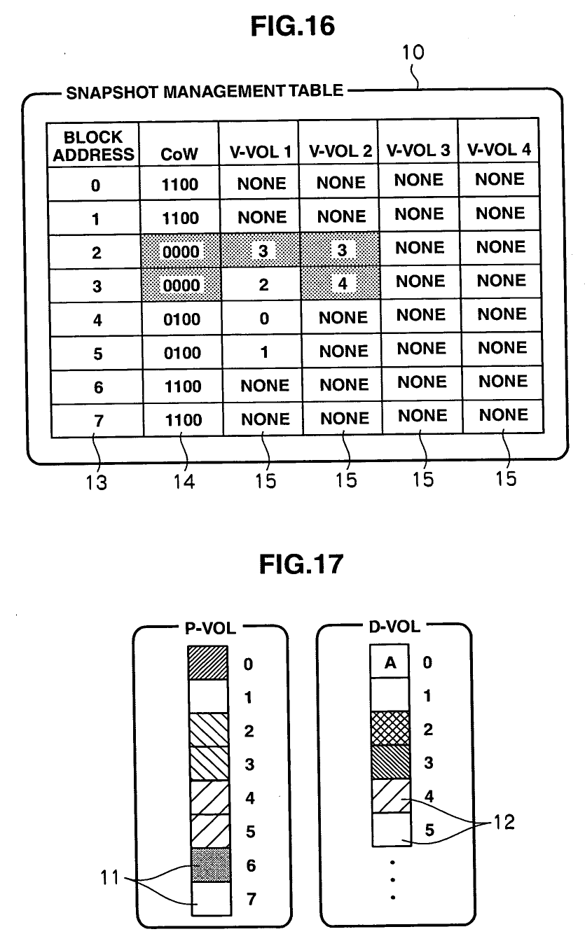

Further, as shown in FIG. 16 later, the CPU 2 clears the second bit from the far left of each of the corresponding CoW bitmaps in the snapshot management table 10. Meanwhile, the CPU 2 also stores the block address of the blocks in the difference volume D-VOL saving each of the corresponding difference data in each of the corresponding save destination block address columns 15 (respective save destination block address columns 15 colored in FIG. 16) corresponding to the “V-VOL 2” row in the snapshot management table 10.

Here, with respect to the block 11 in which the block address in the operation volume P-VOL is “2”, the bit at the far left associated with the first generation snapshot of the corresponding CoW bitmap is also “1”, and it is evident that there was no change in the data up to the creation start time of the second generation snapshot; that is, the data contents of the first generation snapshot creation start time and second generation snapshot creation start time are the same.

Thus, here, the CPU 2 clears the first generation bit of the snapshot in the CoW bitmap of the snapshot management table 10 associated with the block 11 in which the block address of the operation volume P-VOL is “2”, and stores a block address that is the same as the block address stored in the save destination block address column 62 associated with the second generation snapshot in the save destination block address column 62 associated with the first generation snapshot in the snapshot management table 10.

And, when the update of this snapshot management table 10 is complete, the CPU 2 writes the user data in the operation volume P-VOL. Status of the operation volume P-VOL and difference volume D-VOL after the completion of write processing of user data is shown in FIG. 17.

(1-2) Snapshot Data Read Processing

Next, the contents of processing performed by the CPU 2 when a read request is given from the host system for reading data of the snapshot created as described above are explained. Here, let it be assumed that the operation volume P-VOL and difference volume D-VOL are in the state shown in FIG. 17, and the snapshot management table 10 is in the state shown in FIG. 16.

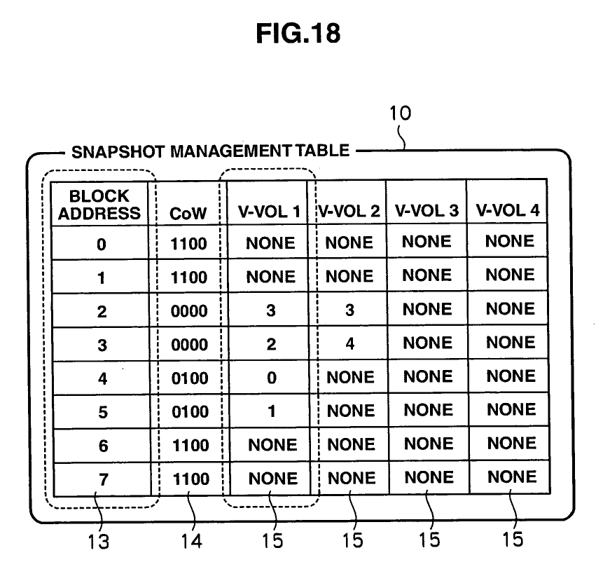

The data to be used during read processing of data of the first generation snapshot is the region surrounded with a dotted line in FIG. 18 among the data in the snapshot management table 10; that is, the data in each block address column 13 and each save destination block address column 15 of the “V-VOL 1” row corresponding to the first generation snapshot.

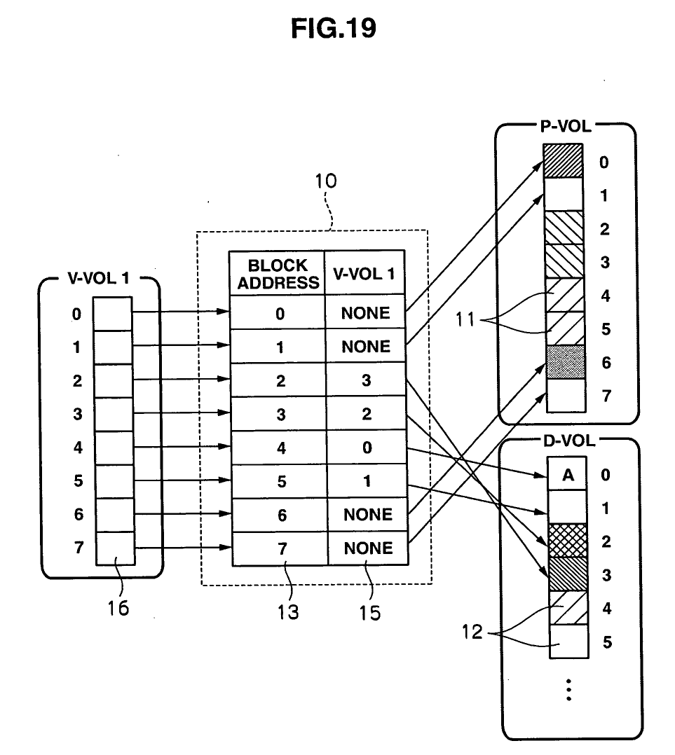

In actuality, as shown in FIG. 19, with respect to the respective blocks 16 of the first generation snapshot, the CPU 2 maps the data stored in the block 11 of the same block address in the operation volume P-VOL to the corresponding block 16 of the first generation snapshot when “None” is stored in the save destination block address column 15 associated with the block address of the block 16 in the snapshot management table 10, and maps the data stored in the block 12 of the block address in the difference volume D-VOL to the corresponding block 16 of the first generation snapshot when the block address is stored in the save destination block address column 62.

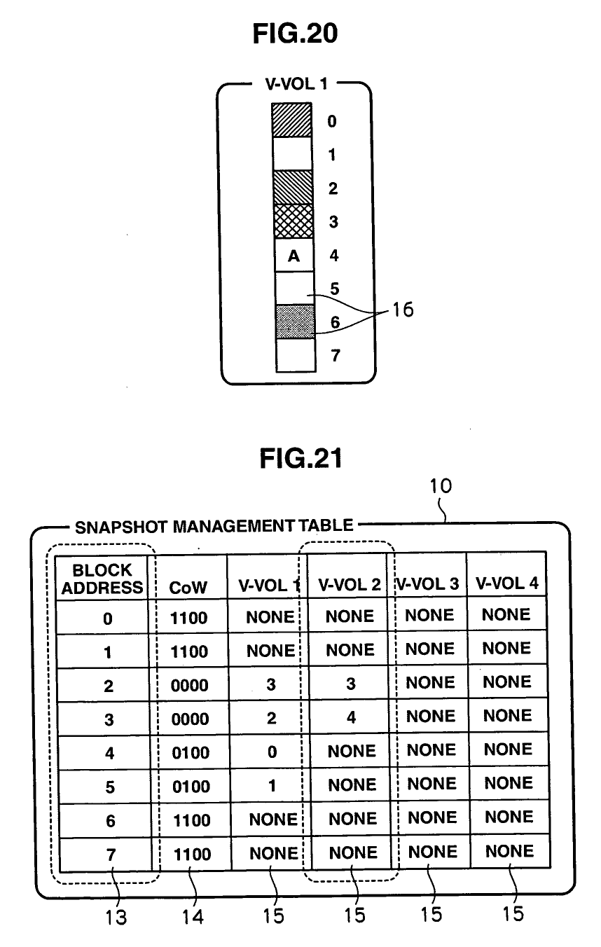

As a result of performing the foregoing mapping processing, it will be possible to create a first generation snapshot as shown in FIG. 20 formed by retaining the image of an operation volume P-VOL the instant a first generation snapshot creation order is given from the host system to the NAS server 1.

Meanwhile, the data to be used during read processing of data of the second generation snapshot is the region surrounded with a dotted line in FIG. 21 among the various data in the snapshot management table 10; that is, the data in each block address column 13 and each save destination block address column 62 of the “V-VOL 2” row corresponding to the second generation snapshot.

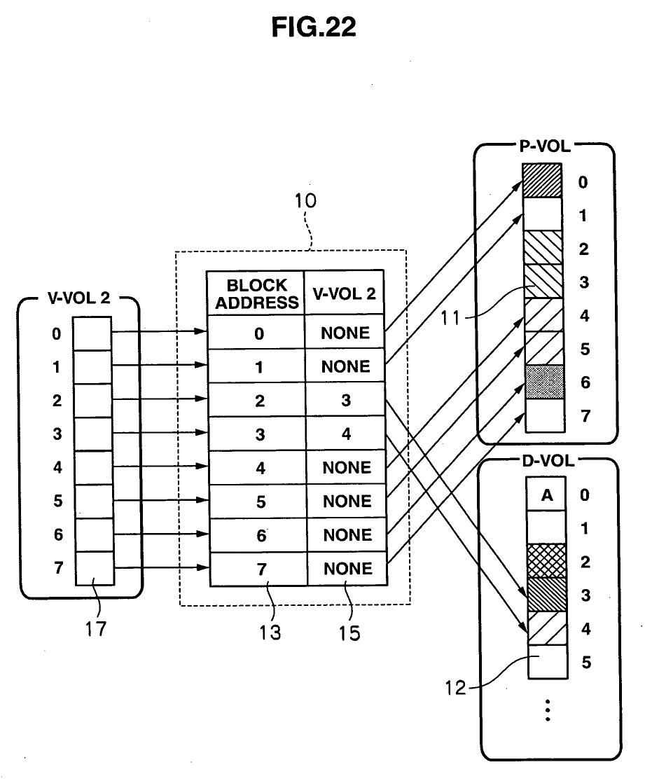

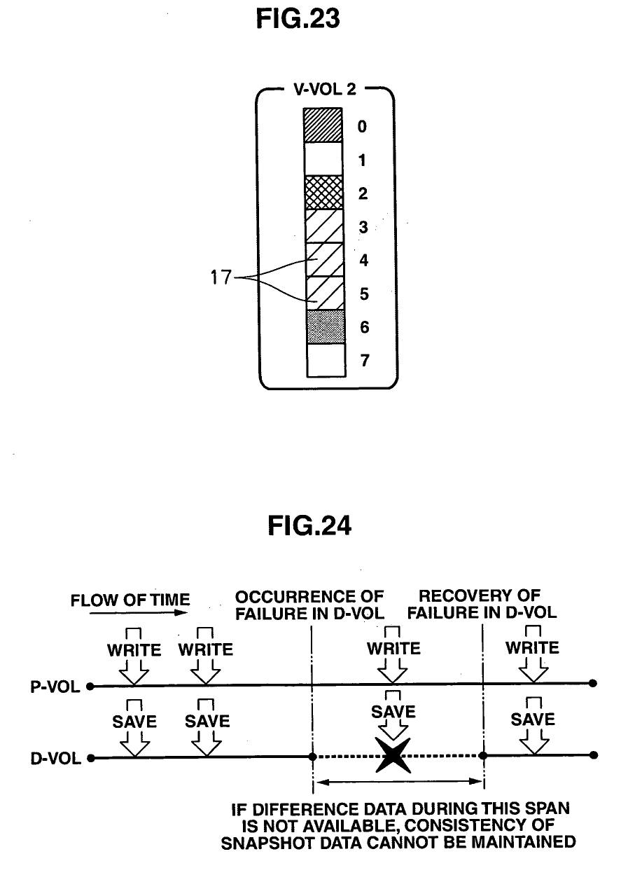

In actuality, as shown in FIG. 22, with respect to the respective blocks 17 of the second generation snapshot, the CPU 2 maps the data stored in the corresponding block 11 of the operation volume P-VOL or the data stored in the corresponding block 12 of the difference volume D-VOL. As a result, it will be possible to create a second generation snapshot as shown in FIG. 23 formed by retaining the image of an operation volume P-VOL the instant a second generation snapshot is created.

(1-3) Problems of Basic Snapshot Function and Description of Snapshot Function According to Present Embodiment

Meanwhile, when a failure occurs in the difference volume D-VOL during the execution of the snapshot function in the NAS server (FIG. 1) equipped with the snapshot function described above, there was no choice but to stop the operation of the snapshot function and wait for the difference volume D-VOL to recover, or delete the relationship with the difference volume D-VOL to continue the operation.

In the foregoing cases, in order to realize a fault-tolerant operation of the NAS server 1, there is no choice but to adopt the latter method as the operation mode of the NAS server 1. Nevertheless, when this method is adopted, snapshots of all generations created theretofore will have to be abandoned. This is because, as shown in FIG. 24, if there is a period where processing for saving the difference data cannot be performed from the occurrence of such failure in the difference volume D-VOL to the recovery thereof, data cannot be written in the operation volume P-VOL. Granted that a user attempts to write user data during this period, there is a possibility that inconsistency in data regarding all snapshots will occur.

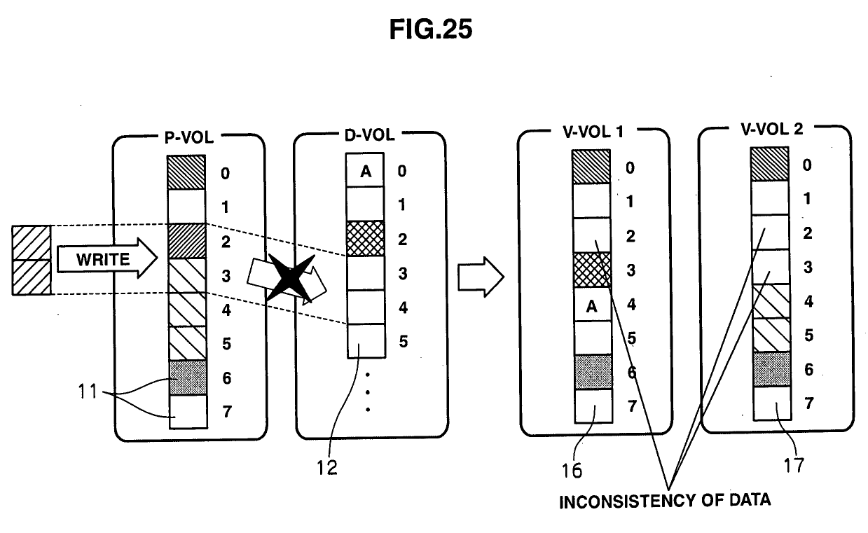

In the case of FIG. 15, for instance, if user data is written in the operation volume P-VOL without saving the difference data, as shown in FIG. 25, in addition to the data of the second generation snapshot (V-VOL 2), data of the first generation snapshot (V-VOL 1) will also become inconsistent and differ from the contents of the operation volume P-VOL at the snapshot creation start time when the failure in the difference volume D-VOL is recovered. Therefore, when a failure occurs in the difference volume D-VOL in the NAS server 1, there is a problem in that all snapshots must be abandoned in order to continue the operation.

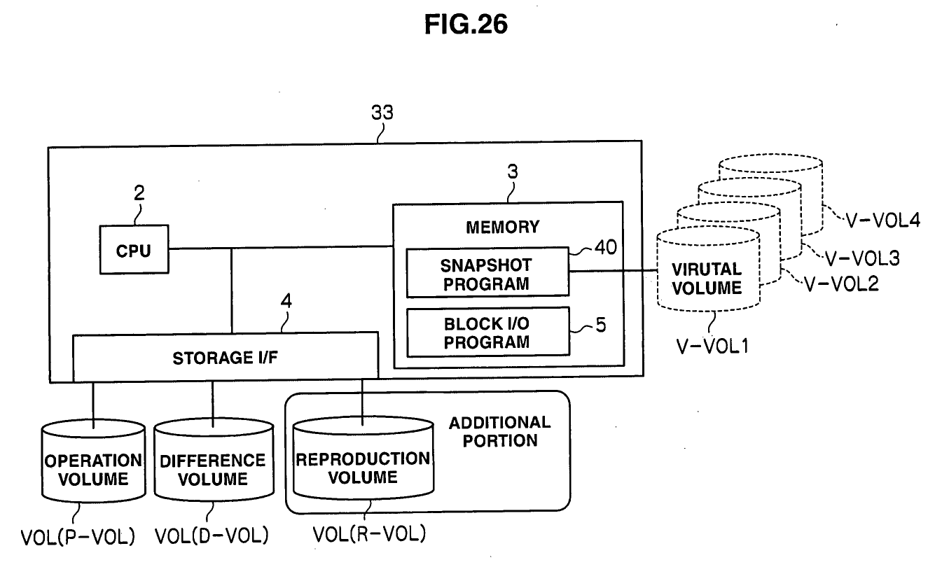

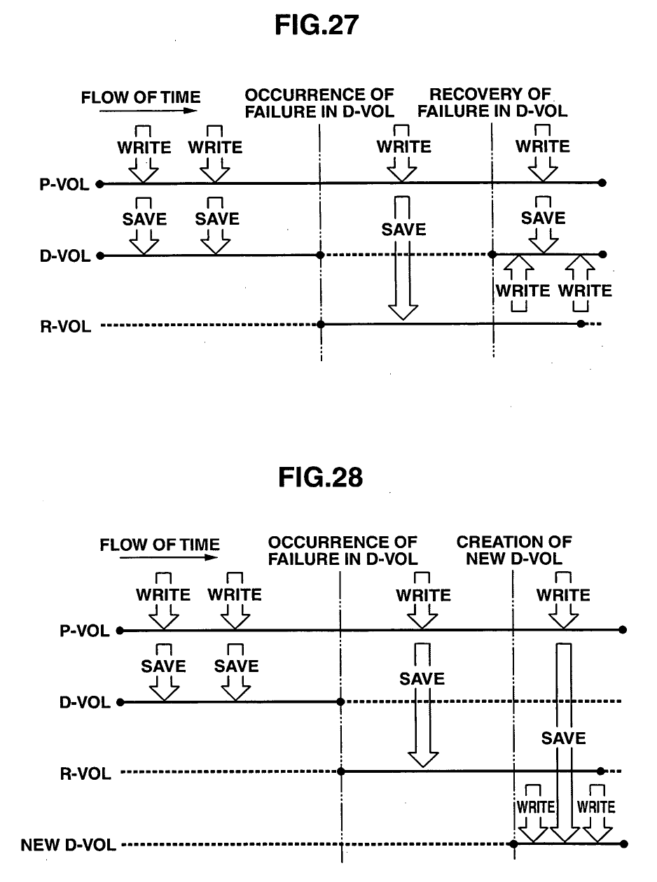

As a means for overcoming the foregoing problems, the present invention, for instance, as shown in FIG. 26 where the same reference numerals are given to the corresponding portions of FIG. 1, provides a reproduction volume R-VOL as a volume to be used in a failure situation (failure-situation volume) separate from the operation volume P-VOL and difference volume D-VOL. And, as shown in FIG. 27, when user data is written in the operation volume P-VOL during the period from the occurrence of a failure in the difference volume D-VOL to the recovery thereof, necessary difference data D-VOL is saved in the reproduction volume R-VOL, and the difference data saved in the reproduction volume R-VOL is migrated to the difference volume D-VOL, while securing the consistency of the snapshot management table 10, after the difference volume D-VOL recovers from its failure. Further, when the failure of the difference volume D-VOL in irrecoverable, as shown in FIG. 28, after creating a new difference volume D-VOL, the difference data saved in the reproduction volume R-VOL is migrated to such new difference volume D-VOL.

According to the snapshot maintenance method described above, even when a failure occurs in the difference volume D-VOL, when the difference volume D-VOL is recoverable, the previous snapshots can be maintained without having to stop the snapshot function or abandoning the snapshots of any generation created theretofore.

The snapshot function according to the foregoing embodiment is now explained.

### (2) Configuration of Network System According to Present Embodiment

(2-1) Configuration of Network System

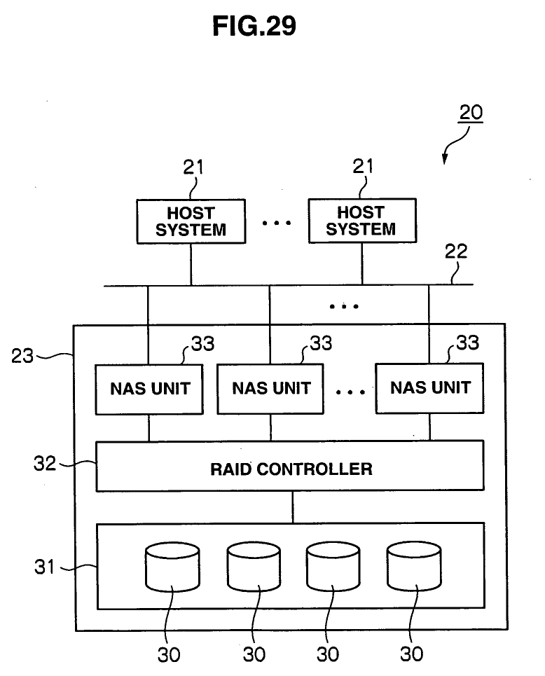

FIG. 29 shows a network system 20 having a disk array device 23 as its constituent element employing the snapshot maintenance method according to the present embodiment. This network system 20 is configured by a plurality of host systems 21 being connected to the disk array device 23 via a network 22.

The host system 21 is a computer device having an information processing resource such as a CPU (Central Processing Unit) and memory, and, for instance, is configured from a personal computer, workstation, mainframe and the like. The host system 21 has an information input device (not shown) such as a keyboard, switch, pointing device or microphone, and an information output device (not shown) such as a monitor display or speaker.

The network 22, for example, is configured from a SAN (Storage Area Network), LAN (Local Area Network), Internet, public line or dedicated line. Communication between the host system 21 and disk array device 23 via this network 22, for instance, is conducted according to a fibre channel protocol when the network 22 is a SAN, and conducted according to a TCP/IP (Transmission Control Protocol/Internet Protocol) protocol when the network 22 is a LAN.

The disk array device 23 is configured from a storage device unit 31 formed from a plurality of disk units 30 for storing data, a RAID controller 32 for controlling the user data I/O from the host system 21 to the storage device unit 31, and a plurality of NAS units 33 for exchanging data with the host system 21.

The respective disk units 30 configuring the storage device unit 31, for instance, are configured by having an expensive disk such as a SCSI (Small Computer System Interface) disk or an inexpensive disk such as a SATA (Serial AT Attachment) disk or optical disk built therein.

Each of these disk units 30 is operated under the RAID system with the RAID controller 32. One or more logical volumes VOL (FIG. 26) are set on a physical storage area provided by one or more disk units 30. And, a part of such set logical volumes VOL is defined as the operation volume P-VOL (FIG. 26), and the user data subject to writing transmitted from the host system 21 is stored in this operation volume P-VOL in block units of a prescribed size (hereinafter referred to as a “logical block”).

Further, another part of the logical volume VOL is defined as a difference volume D-VOL (FIG. 26) or a reproduction volume R-VOL (FIG. 26), and difference data is stored in such difference volume D-VOL or reproduction volume R-VOL. Incidentally, a logical volume VOL set in a physical storage area provided by a highly reliable disk unit 30 is assigned as the reproduction volume R-VOL. However, a highly reliable external disk device such as a SCSI disk or fibre channel disk may be connected to the disk array device 23, and the reproduction volume R-VOL may also be set in the physical storage area provided by this external disk device.

A unique identifier (LU: Logical Unit number) is provided to each logical volume VOL. In the case of the present embodiment, the input and output of user data is conducted based on an address obtained by combining this identifier and a number unique to the logical block thereof (LBA: Logical Block Address) provided to the respective logical blocks, and designating this address.

The RAID controller 32 has a microcomputer configuration including a CPU, ROM and RAM, and controls the input and output of user data between the NAS unit 33 and storage device 31. The NAS unit 33 has a blade structure, and is removably mounted on the disk array device 23. This NAS unit 33 is equipped with various functions such as a file system function for providing a file system to the host system 21 and a snapshot function according to the present embodiment described later.

FIG. 26 described above shows a schematic configuration of this NAS unit 33. As clear from FIG. 26, the NAS unit 43 according to the present embodiment is configured the same as the NAS server 1 described with reference to FIG. 1 other than that the configuration of the snapshot program 40 stored in the memory 3 is different.

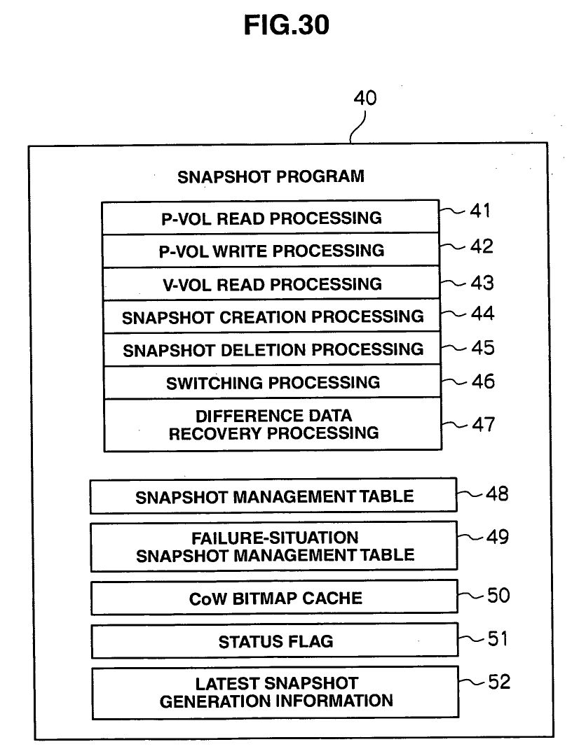

The snapshot program 40, as shown in FIG. 30, is configured from an operation volume read processing program 41, an operation volume write processing program 42, a snapshot data read processing program 43, a snapshot creation processing program 44, a snapshot deletion processing program 45, a switching processing program 46 and a difference data recovery processing program 47, and a snapshot management table 48, a failure-situation snapshot management table 49, a CoW bitmap cache 50, a status flag 51 and latest snapshot generation information 52.

Among the above, the operation volume read processing program 41 and operation volume write program 42 are programs for executing the read processing of user data from the operation volume P-VOL or write processing of user data in the operation volume P-VOL, respectively. The operation volume read processing program 41 and operation volume write program 42 configure the block I/O program 5 depicted in FIG. 26. Further, the snapshot data read processing program 43 is a program for executing read processing of data of the created snapshot.

The snapshot creation processing program 44 and snapshot deletion processing program 45 are programs for executing generation processing of a new generation snapshot or deletion processing of an existing snapshot. Further, the switching processing program 46 is a program for executing switching processing for switching the save destination of difference data from the difference volume D-VOL to the reproduction volume R-VOL. The difference data recovery processing program 47 is a program for executing difference data recovery processing of migrating difference data saved in the reproduction volume R-VOL to the difference volume D-VOL when the difference volume D-VOL is recovered.

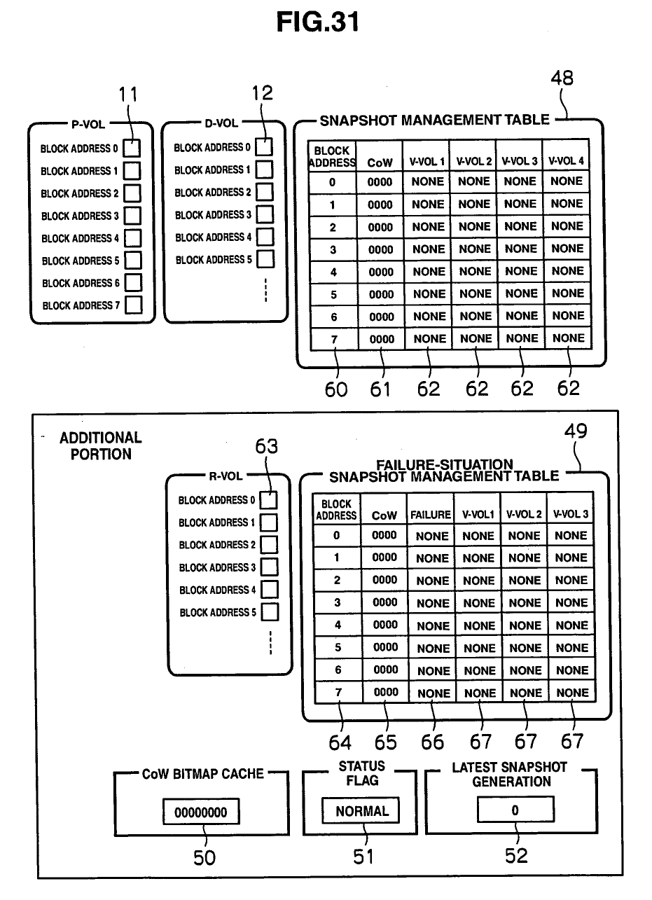

Meanwhile, the snapshot management table 48, as shown in FIG. 31, has the same configuration as the snapshot management table 10 described with reference to FIG. 2, and is provided with a block address column 60, a CoW bitmap column 61, and a plurality of save destination block address columns 62 respectively associated with the first to fourth generation snapshots in correspondence with each block 11 of the operation volume P-VOL. As described above, data management of snapshots in the respective generations when the difference data is saved in the difference volume D-VOL is conducted with this snapshot management table 48.

Further, the failure-situation snapshot management table 49 is used for data management of snapshots in the respective generations when the difference data is not saved in the reproduction volume R-VOL. This failure-situation snapshot management table 49 has the same configuration as the snapshot management table 48 other than that a “Failure” address column 66 is provided in addition to being provided with an address column 64, a CoW bitmap column 65 and a plurality of address columns 67 respectively associated with the first to third generation snapshots in correspondence with each block 11 of the operation volume P-VOL.

However, in the failure-situation snapshot management table 49, the generation of the latest snapshot corresponds to “Failure” when a failure occurs in the difference volume D-VOL, and any snapshot created thereafter corresponds, in order, to a first generation (“V-VOL 1”), a second generation (“V-VOL 2”) and a third generation (“V-VOL 3”). Accordingly, for instance, when a failure occurs in the difference volume D-VOL when creating a second generation snapshot, even when a third generation snapshot is created thereafter, such snapshot will correspond to the first generation in the failure-situation snapshot management table 49.

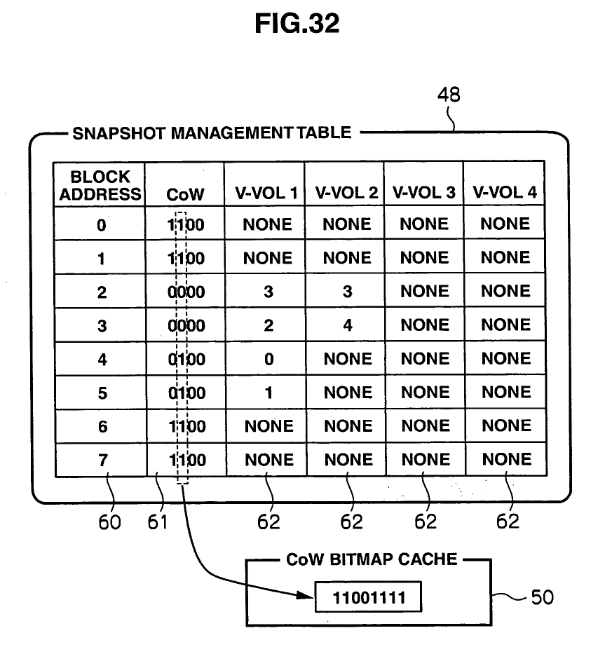

The CoW bitmap cache 50 is a cache for storing a bit string formed by extracting and arranging bits corresponding to the latest snapshot in the order of block addresses among the respective CoW bitmaps stored in each CoW bitmap column 61 in the snapshot management table 48. For example, in the state shown in FIG. 32, since the latest snapshot is a second generation, the second bit from the far left of each CoW bitmap in the snapshot management table 48 is arranged in the order of the block addresses and stored in the CoW bitmap cache 50.

The status flag 51 is a flag showing the status of the difference volume D-VOL in relation to the failure status, and retains a value of “Normal”, “Failure” or “Recovered”. Further, the latest snapshot generation information 52 stores the generation of the latest snapshot with the time in which the failure occurred in the difference volume D-VOL as the reference. For example, when a failure occurs in the difference volume D-VOL upon creating the second generation snapshot, a value of “2” is stored in the latest snapshot generation information 52.

(2-2) Various Processing of Disk Array Device

Next, the contents of processing to be performed by the CPU 2 (FIG. 26) of the NAS unit 33 (FIG. 26) in the disk array device 23 (FIG. 29) upon performing write processing of user data in the operation volume P-VOL, read processing of user data from the operation volume P-VOL, read processing of snapshot data, generation processing of a new generation snapshot, deletion processing of a created snapshot, and difference data recovery processing of writing difference data saved in the reproduction volume in the difference volume D-VOL that recovered from the failure are explained.

(2-2-1) Write Processing of User Data in Operation Volume

Foremost, the contents of processing to be performed by the CPU 2 in the write processing of user data in the operation volume P-VOL are explained.

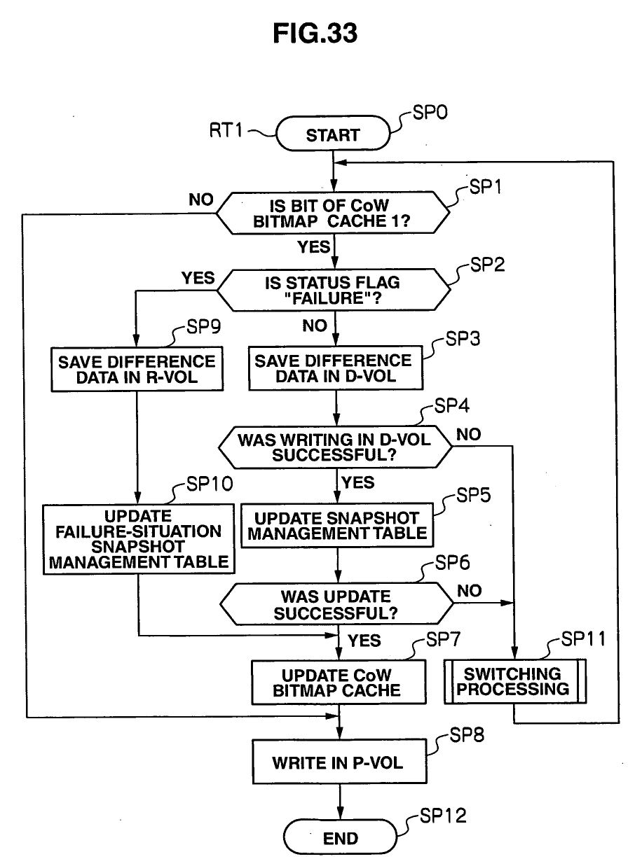

FIG. 33 is a flowchart showing the contents of processing to be performed by the CPU 2 of the NAS unit 33 in a case where a write request of user data in the operation volume P-VOL is provided from the host system 21 (FIG. 29) to the disk array device 23 having the foregoing configuration. The CPU 2 executes this write processing based on the operation volume write processing program 40 (FIG. 31) of the snapshot program 40.

In other words, when the CPU 2 receives this write request, it starts the write processing (SP0), and foremost accesses the snapshot management table 48 (FIG. 30) of the snapshot program 40 (FIG. 30) stored in the memory 3 (FIG. 26), and then determines whether or not the bit associated with the current snapshot generation of the CoW bitmap corresponding to the block 11 in the operation volume P-VOL subject to the write request is “1” (SP1).

To obtain a negative result at step SP1 (SP1: NO) means that the current snapshot generation has already been saved in the difference data D-VOL. Thus, the CPU 2 in this case proceeds to step SP8.

Contrarily, to obtain a positive result in the determination at step SP1 (SP1: YES) means that the difference data of the current snapshot generation has not yet been saved. Thus, the CPU 2 in this case reads the status flag 51 in the snapshot program 40, and determines whether or not this is a “Failure” (SP2).

And, when the CPU 2 obtains a negative result in this determination (SP2: NO), it saves the difference data in the difference volume D-VOL (SP3), and thereafter determines whether or not the writing of difference data in such difference volume D-VOL was successful (SP4). When the CPU 2 obtains a positive result in this determination (SP4: YES), it updates the snapshot management table 48 in accordance therewith (SP5), and further determines whether or not the update of such snapshot management table 48 was successful (SP6).

When the CPU 2 obtains a positive result in this determination (SP6: YES), it updates the contents of the CoW bitmap cache 50 according to the updated snapshot management table 48 (SP7), thereafter writes in the operation volume P-VOL the user data subject to writing provided from the host system 21 together with the write request (SP8), and then ends this write processing (SP12).

Contrarily, when the CPU 2 obtains a positive result in the determination at step SP2 (SP2: YES), it saves the difference data in the reproduction volume R-VOL (SP9), updates the failure-situation snapshot management table 49 in accordance therewith (SP10), and thereafter proceeds to step SP7. And, the CPU 2 thereafter performs the processing of step SP7 and step SP8 in the same manner as described above, and then ends this write processing (SP12).

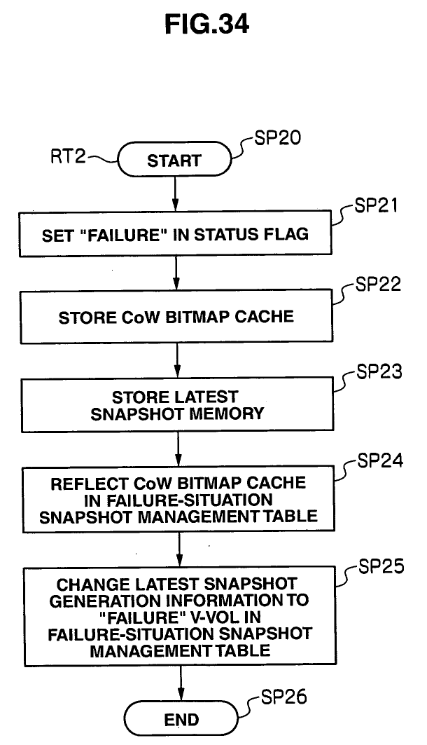

Meanwhile, when the CPU 2 obtains a negative result in the determination at step SP4 or step SP6 (SP4: NO, SP6: NO), it proceeds to step SP11, and thereafter switches the save destination of user data from the difference volume D-VOL to the reproduction volume R-VOL based on the switching processing program 46 (FIG. 30) of the snapshot program 40 and in accordance with the flowchart procedures shown in FIG. 34.

In other words, when the CPU 2 proceeds to step SP11 of the foregoing write processing, it starts this switching processing (SP20), and foremost sets “Failure” to the status flag 51 in the snapshot program 40 (SP21).

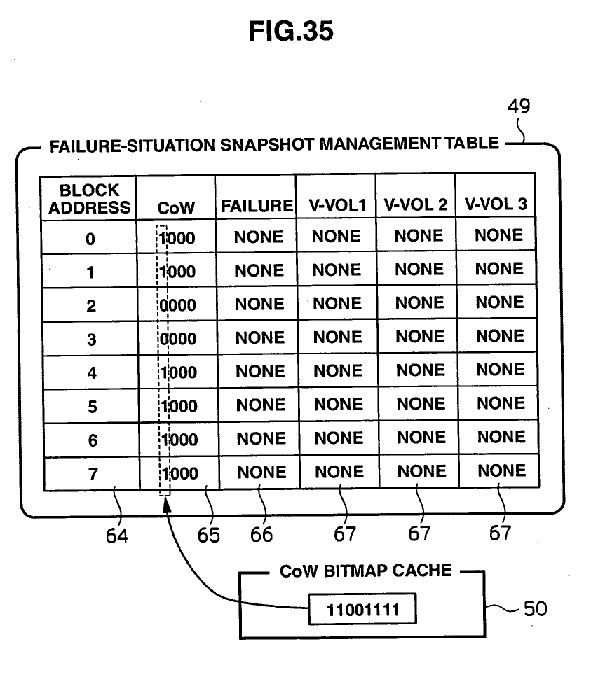

Next, the CPU 2 respectively stores the CoW bitmap cache 50 of the snapshot program 40 and the latest snapshot generation information 52 (SP22, SP23), and thereafter reflects the contents of the CoW bitmap cache 50 in the failure-situation snapshot management table 49. Specifically, as shown in FIG. 35, the CPU 2 copies the value of the corresponding bit of the bit string stored in the CoW bitmap cache 50 to the bit corresponding to the current snapshot generation in the respective CoW bitmaps in the failure-situation snapshot management table 49 (SP24).

Next, the CPU 2 changes the generation of the snapshot to which a failure has occurred being stored as the latest snapshot generation information 52 into a “Failure” snapshot generation in the failure-situation snapshot management table 49 (SP25), and thereafter ends this switching processing (SP26). And, the CPU 2 thereafter returns from step SP11 to step SP1 of the foregoing write processing described with reference to FIG. 33.

Accordingly, when the writing of difference data in the difference volume D-VOL or the update of the snapshot management table 48 ends in a failure (SP4: NO, SP6: NO), after the save destination volume of the difference data is switched from the difference volume D-VOL to the reproduction volume R-VOL, difference data is stored in the reproduction volume R-VOL according to the procedures of steps in the order of SP1-SP2-SP9-SP10-SP7-SP8.

(2-2-2) Read Processing of User Data from Operation Volume

Although the read processing of user data from the operation volume P-VOL is performed under the control of the CPU 2 based on the operation volume read processing program 42 (FIG. 30) of the snapshot program 40, the explanation thereof is omitted since the processing contents are the same as conventional processing.

(2-2-3) Read Processing of Snapshot Data

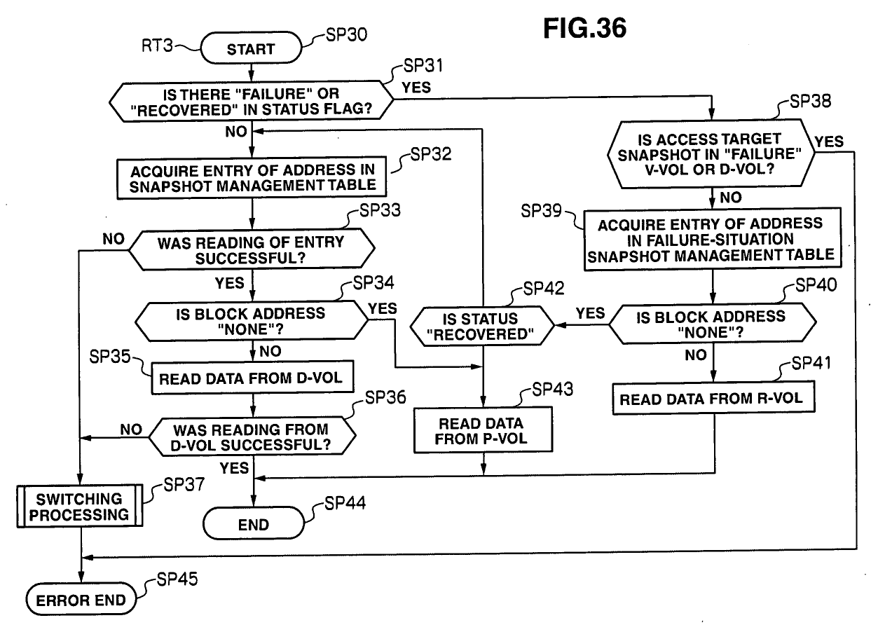

Next, the contents of processing to be performed by the CPU 2 in the data read processing of the created snapshot is explained. FIG. 36 is a flowchart showing the contents of processing to be performed by the CPU 2 when the snapshot generation, block address and so on are designated, and a read request for reading the data of the block address of the snapshot of such generation (hereinafter referred to as the “snapshot data read request”) is provided from the host system 21. The CPU 2 executes this processing based on the snapshot data read processing program 43 (FIG. 30) of the snapshot program 40.

In other words, when the CPU 2 if given a snapshot data read request designating the snapshot generation, block address and so on, it starts this snapshot data read processing (SP30), and foremost reads the status flag 51 (FIG. 30) in the snapshot program 40, and determines whether this is representing the status of “Failure” or “Recovered” (SP31).

When a negative result is obtained in the determination at step SP31 (SP31: NO), this means that the difference volume D-VOL is currently being operated, and the difference data is saved in the difference volume D-VOL. Thus, the CPU 2 in this case reads the block address stored in the save destination block address column 62 associated with the snapshot generation and block address designated in the snapshot management table 48 (SP32), and thereafter determines whether the reading of such block address was successful (SP33).

When the CPU 2 obtains a positive result in this determination (SP33: YES), it determines whether or not the read block address is “None” (SP34). When the CPU 2 obtains a positive result (SP34: YES), it proceeds to step 43, and, when the CPU 2 obtains a negative result (SP34: NO), it reads the user data stored in the block 12 of block address read at step SP32 in the difference volume D-VOL (SP35).

Further, the CPU 2 thereafter determines whether or not the reading of user data from the difference volume D-VOL was successful (SP36), and, when the CPU 2 obtains a positive result (SP36: YES), it ends this snapshot data read processing (SP44).

Contrarily, when the CPU 2 obtains a negative result in the determination at step SP33 or in the determination at step SP36 (SP33: NO, SP36: YES), it switches the save destination of difference data from the difference volume D-VOL to the reproduction volume R-VOL (SP37) by executing the switching processing described with reference to FIG. 34. Further, the CPU 2 thereafter executes prescribed error processing such as by notifying an error to the host system 21 that transmitted the snapshot data read request, and then ends this snapshot data read processing (SP45). Incidentally, the processing at step SP38 is hereinafter referred to as “error end processing”.

Meanwhile, to obtain a negative result in the determination at step SP31 (SP31: YES) means that the difference volume D-VOL is not currently being operated, and that the difference data is saved in the reproduction volume R-VOL. Thus, the CPU 2 in this case determines whether or not the block subject to data reading designated by the user is a block belonging to either the snapshot of the generation to which a failure occurred, or the difference volume D-VOL (SP38).

And, when the CPU 2 obtains a positive result in this determination (SP38: YES), it error-ends this snapshot data read processing (SP45), and, contrarily, when the CPU 2 obtains a negative result (SP38: NO), it reads the block address stored in the address column 67 (FIG. 31) corresponding to the snapshot generation and block address designated by the user in the failure-situation snapshot management table 49 (SP39), and thereafter determines whether or not the read block address is “None” (SP40).

When the CPU 2 obtains a negative result in this determination (SP40: NO), it reads the user data stored in the block of the block address acquired at step SP39 in the reproduction volume R-VOL (SP41), and thereafter ends this snapshot data read processing (SP44).

Meanwhile, when the CPU 2 obtains a positive result in the determination at step SP40 (SP40: YES), it reads the status flag 51 (FIG. 30) in the snapshot program 40, and determines whether or not “Recovered” is set to the status flag (SP42).

To obtain a positive result in this determination (SP42: YES) means that the user data saved in the reproduction volume R-VOL is currently being written in the difference volume D-VOL that recovered from the failure. Thus, the CPU 2 in this case returns to step SP32, and thereafter executes the processing subsequent to step SP32 as described above.

Contrarily, to obtain a negative result in the determination at step SP42 (SP42: NO) means that a failure occurred in the difference volume D-VOL, and that the difference volume D-VOL has not yet been recovered. Thus, the CPU 2 in this case reads data from the operation volume P-VOL (SP43), and thereafter ends this snapshot data read processing (SP44).

(2-2-4) Snapshot Creation Processing

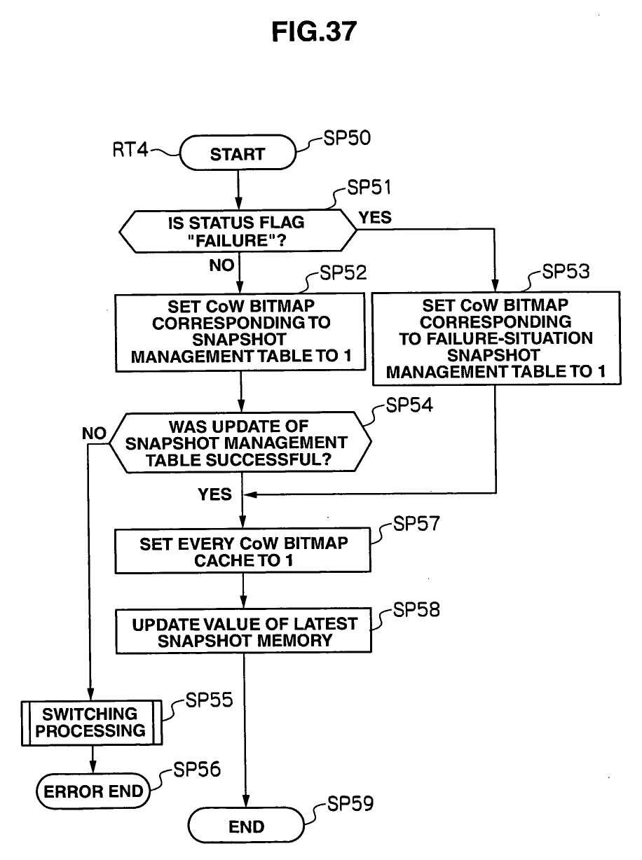

FIG. 37 is a flowchart showing the contents of processing to be performed by the CPU 2 in relation to the snapshot generation processing. When the CPU 2 is given a snapshot creation order from the host system 21 (FIG. 29), it executes generation processing of a new snapshot based on the snapshot creation processing program 44 (FIG. 30) of the snapshot program 40 in accordance with the processing procedures shown in this flowchart.

In other words, when the CPU 2 is given a snapshot creation order, it starts the snapshot creation processing (SP50), and foremost reads the status flag 51 in the snapshot program 40, and determines whether or not “Failure” is set to this status flag 51 (SP51).

When the CPU 2 obtains a negative result in this determination (SP51: NO), it sets the respective values of the bits corresponding to the generation of the snapshot to be created in each CoW bitmap in the snapshot management table 48 to 1 (SP52), and thereafter determines whether or not the update of the snapshot management table 48 was successful (SP54).

When the CPU 2 obtains a negative result in this determination (SP54: NO), it switches the save destination of difference data from the difference volume D-VOL to reproduction volume R-VOL (SP55) by executing the foregoing switching processing described with reference to FIG. 34, and thereafter error-ends this snapshot creation processing (SP56).

Contrarily, when the CPU 2 obtains a positive result in the determination at step SP54 (SP54: YES), it sets every value of the respective bits of the bit string stored in the CoW bitmap cache 50 of the snapshot program 40 to 1 (SP57). Further, the CPU 2 thereafter updates the latest snapshot generation information 52 to the value of the generation of the snapshot at such time (SP58), and then ends this snapshot creation processing (SP59).

Meanwhile, when the CPU 2 obtains a negative result in the determination at step SP51 (SP51: YES), it sets the respective values of the bits corresponding to the generation of the snapshot to be created in each CoW bitmap in the failure-situation snapshot management table 49 to 1 (SP53). Then, the CPU 2 sets every value of the respective bits of the bit string stored in the CoW bitmap cache 50 of the snapshot program 40 to 1 (SP57), updates the latest snapshot generation information 52 to the value of the generation of the snapshot at such time (SP58), and thereafter ends this snapshot creation processing (SP59).

(2-2-5) Snapshot Deletion Processing

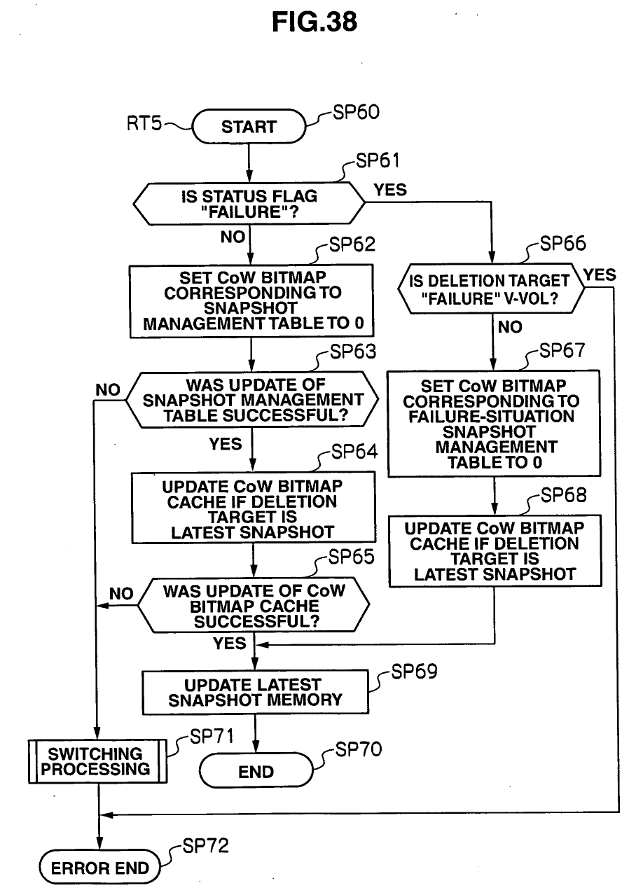

Meanwhile, FIG. 38 is a flowchart showing the contents of processing to be performed by the CPU 2 in relation to the deletion processing of the snapshot. When the CPU 2 is given a deletion order of the snapshot from the host system 21 (FIG. 29), it executes deletion processing of the designated snapshot based on the snapshot deletion processing program 45 (FIG. 30) of the snapshot program 40, and in accordance with the processing procedures shown in this flowchart.

In other words, when the CPU 2 is given a snapshot creation order, it starts the snapshot deletion processing (SP60), and foremost reads the status flag 51 in the snapshot program 40, and determines whether “Failure” is set to this status flag 51 (SP61).

When the CPU 2 obtains a negative result in this determination (SP61: NO), it sets the respective values of the bits corresponding to the generation of the snapshot to be deleted in each CoW bitmap in the snapshot management table 48 to “0” (SP62), and thereafter determines whether the update of the snapshot management table 48 was successful (SP63).

When the CPU 2 obtains a positive result in this determination (SP63: YES), it updates the contents of the CoW bitmap cache 50 in the snapshot program 40 to the contents corresponding to the snapshot of a generation preceding the snapshot subject to deletion when the snapshot subject to deletion is the latest snapshot (SP64). Specifically, the CPU 2 reads the respective values of the bits associated with the generation preceding the snapshot subject to deletion in each CoW bitmap in the snapshot management table 48, and arranges these in the order of the corresponding block addresses and writes these in the CoW bitmap cache 50 (SP64).

And, when the CPU 2 thereafter determines whether the update of the CoW bitmap cache 50 was successful (SP65) and obtains a positive result (SP65: YES), it updates the value of the latest snapshot generation information 52 in the snapshot program 40 to the value of the snapshot generation (SP69), and thereafter ends this snapshot deletion processing (SP70).

Contrarily, when the CPU 2 obtains a negative result in the determination at step SP63 or step SP65 (SP63: NO, SP65: NO), it switches the save destination of difference data from the difference volume D-VOL to the reproduction volume R-VOL (SP71) by executing the foregoing switching processing described with reference to FIG. 34, and thereafter error-ends this snapshot deletion processing (SP72).

Meanwhile, when the CPU 2 obtains a positive result in the determination at step SP61 (SP61: YES), it determines whether or not the snapshot in which a failure occurred is the snapshot subject to deletion (SP66). And, when the CPU 2 obtains a positive result in this determination (SP66: YES), it error-ends this snapshot deletion processing (SP72).

Contrarily, when the CPU 2 obtains a negative result in the determination at step SP66 (SP66: NO), it sets the respective values of the bits corresponding to the generation of the snapshot to be deleted in each CoW bitmap in the failure-situation snapshot management table 49 to “0” (SP67).

Further, when the snapshot subject to deletion is the latest snapshot, the CPU 2 thereafter updates the contents of the CoW bitmap cache 50 in the snapshot program 40 to the contents corresponding to the snapshot of a generation preceding the snapshot subject to deletion (SP68). Specifically, the CPU 2 reads the respective values of the bits corresponding to the generation preceding the snapshot subject to deletion in each CoW bitmap in the failure-situation snapshot management table 49, and arranges these in the order of the corresponding block addresses and writes these in the CoW bitmap cache 50 (SP68).

And, the CPU 2 thereafter updates the value of the latest snapshot generation information 52 in the snapshot program 40 to the new snapshot generation (SP69), and then ends this snapshot deletion processing (SP70).

(2-2-6) Difference Data Recovery Processing

Next, difference data recovery processing is explained. This difference data recovery processing is executed when a recovery processing order of difference data is given from the system administrator in a case where the difference volume D-VOL in which a failure had occurred has recovered, or in a case where a new difference volume D-VOL is created since the difference volume D-VOL was irrecoverable.

For example, when the difference volume D-VOL recovers from its failure, the difference data saved in the reproduction volume R-VOL is migrated to the difference volume D-VOL, and the contents of the failure-situation snapshot management table 49 are reflected in the snapshot management table 48 pursuant thereto. Data migration in such a case is performed based on the latest snapshot generation information 52 in the snapshot program 40. Further, the saving of difference data from the operation volume P-VOL during this time is conducted based on the contents of the CoW bitmap cache 50 in the snapshot program 40. Further, data migration of difference data from the reproduction volume R-VOL is conducted while retaining the consistency of the snapshot management table 48 and the failure-situation snapshot management table 49.

Since data migration from the reproduction volume R-VOL targets the difference data stored in the block where the value of the bit in the CoW bitmap in the failure-situation snapshot management table 49 is “0”, this can be performed in parallel without being in conflict with the saving of difference data from the operation volume P-VOL.

Here, “None” is stored in the address column 67 in the failure-situation snapshot management table 49 of the difference data migrated to the difference volume D-VOL. However, during this difference data recovery processing, snapshots acquired prior to the occurrence of a failure cannot be accessed. This is because unrecovered difference data in the reproduction volume R-VOL may be referred to, and mapping from the snapshot management table 48 to an area in the reproduction volume R-VOL is not possible.

When the difference volume D-VOL cannot be recovered from its failure, only the difference data corresponding to the snapshot acquired after the occurrence of the failure; that is, the difference data regarding the snapshot of generations after the first generation snapshot in the failure-situation snapshot management table 49, is migrated to the newly set difference volume D-VOL.

In this case, the determination of whether the failure of the difference volume D-VOL is recoverable or irrecoverable is conducted by the system administrator. When the system administrator determines that the difference volume D-VOL is recoverable, he/she performs processing for recovering the difference volume D-VOL, and, contrarily, when the system administrator determines that the difference volume D-VOL is irrecoverable, he/she sets a new difference volume D-VOL.

However, the configuration may also be such that the CPU 2 of the NAS unit 33 automatically determines whether the difference volume D-VOL is recoverable or irrecoverable, and automatically creates a new difference volume D-VOL when it determines that the original difference volume D-VOL is irrecoverable. Specifically, for instance, the CPU 2 calculates the mean time to repair (MTTR: Mean Time To Repair) relating to the disk failure from past log information or the like, waits for the elapsed time from the occurrence of the failure to the current time to exceed the mean time to repair, and determines that the failure of the difference volume D-VOL is recoverable at the stage when such elapsed time exceeds the mean time to repair. As a result, it is anticipated that the response to failures in the difference volume D-VOL can be sped up in comparison to cases of performing this manually.

Details regarding the contents of difference data recovery processing are now explained. The difference data recovery processing is conducted in the order of reflecting the CoW bitmap cache in the snapshot management table 49, and then migrating the difference data to the difference volume D-VOL.

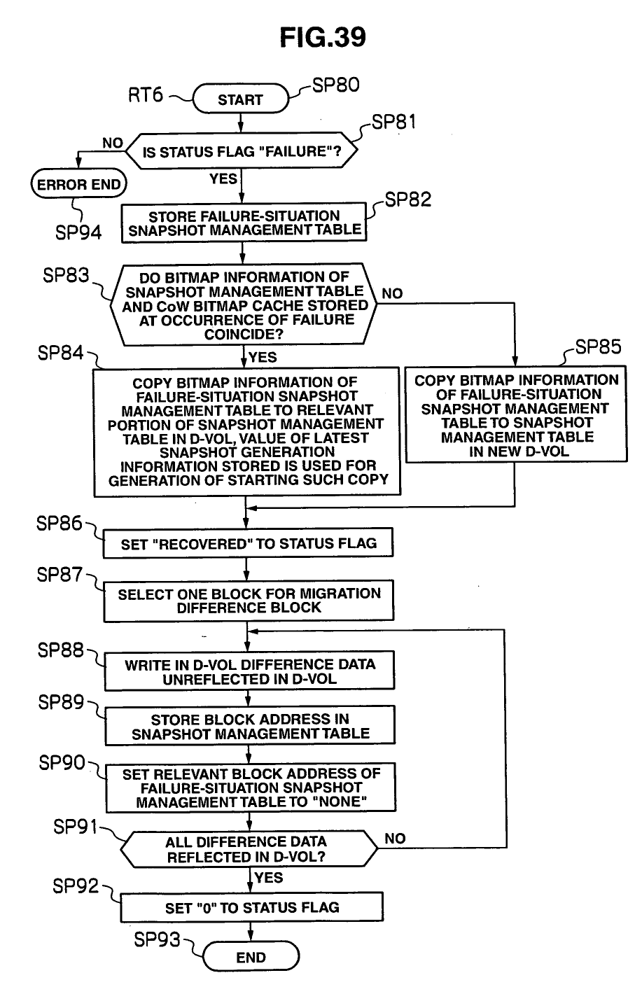

FIG. 39 is a flowchart showing the contents of processing to be performed by the CPU 2 in relation to the recovery processing of difference data. When the CPU 2 is given a recovery order of the difference data from the host system 21, it executes the foregoing difference data recovery processing based on the difference data recovery processing program 47 (FIG. 30) of the snapshot program 40, and in accordance with this flowchart.

In other words, when the CPU 2 is given a recovery order of difference data, it starts the difference data recovery processing (SP80), and foremost reads the status flag of the snapshot program, and determines whether “Failure” is set thereto (SP81). And when the CPU 2 obtains a negative result in this determination (SP81: NO), it error-ends this difference data recovery processing (SP94).

Contrarily, when the CPU 2 obtains a positive result in this determination (SP81: YES), it stores the failure-situation snapshot management table 49, and thereafter determines whether or not the values of the bits corresponding to the latest snapshot in each CoW bitmap in the current snapshot management table 48 completely coincides with the values of the corresponding bits in the bit string stored in the CoW bitmap cache 50 at the time the failure occurred that was stored at step SP22 of the switching processing shown in FIG. 34 (SP83).

To obtain a positive result in this determination (SP83: YES) means that the current difference volume D-VOL is a difference volume D-VOL that was subject to a failure but recovered thereafter. Thus, the CPU 2 in this case sequentially copies the bit at the far left in each CoW bitmap in the failure-situation snapshot management table 49 to the bit corresponding to the current snapshot generation to the bit position of the corresponding generation of the corresponding CoW bitmap in the snapshot management table 48 (SP84). Here, the CPU 2 conducts the association of the snapshot generation in the failure-situation snapshot management table 49 and the snapshot generation in the snapshot management table 48 based on the latest snapshot generation information 52.

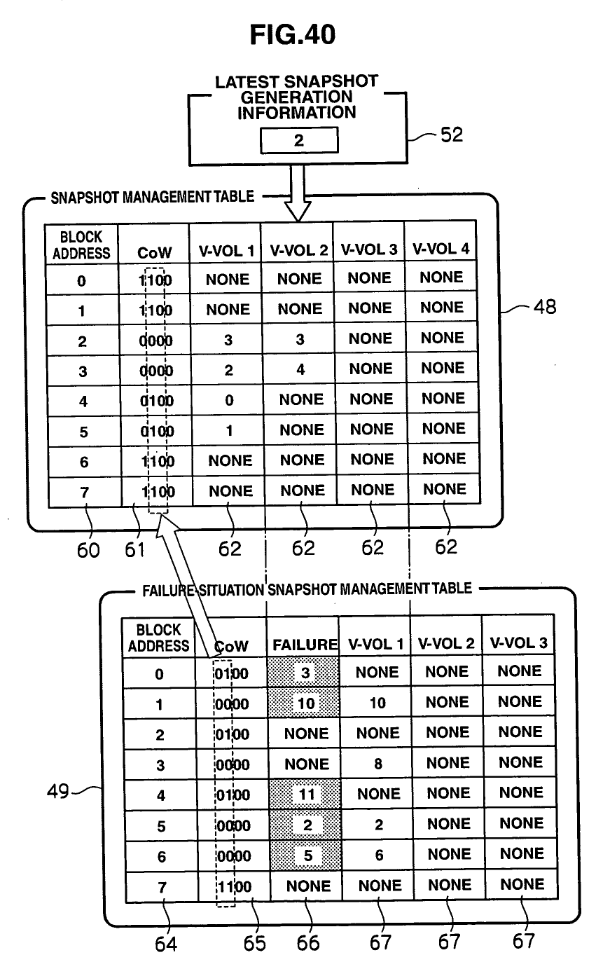

For instance, in the example shown in FIG. 40, the snapshot generation subject to a failure is a second generation based on the latest snapshot generation information 52 stored at step SP22 of the switching processing shown in FIG. 34, and, therefore, it is evident that the “Failure” generation in the failure-situation snapshot management table 49 and the second generation (“V-VOL 2”) in the snapshot management table 48 are in correspondence.

Thus, the CPU 2 respectively copies the bit at the far left in each CoW bitmap of the failure-situation snapshot management table 49 to the bit (second bit from the far left) corresponding to the current snapshot generation (“V-VOL 1”) in the failure-situation snapshot management table 49 to a portion after the bit (second from the far left) corresponding to the second generation snapshot in the corresponding CoW bitmap in the snapshot management table 48. As a result of this kind of processing, it will become possible thereafter to perform the saving of difference data from the operation volume P-VOL to the difference volume D-VOL in parallel with the migration of difference data from the reproduction volume R-VOL to the difference volume D-VOL.

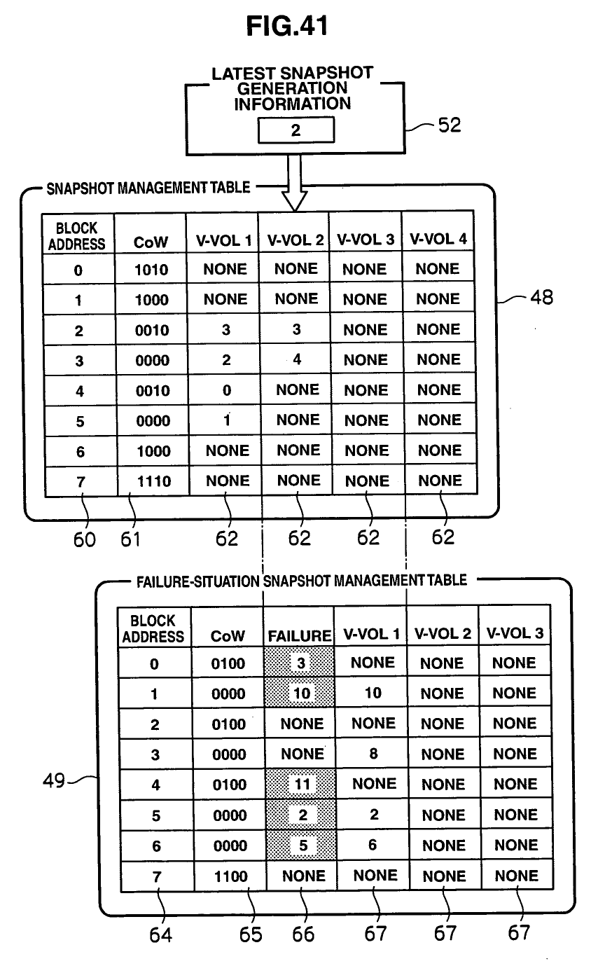

Incidentally, FIG. 41 shows the situation of the snapshot management table 48 after the completion of the processing at step SP83. In FIG. 41, the difference data of the portion corresponding with the address column 67 colored in the failure-situation snapshot management table 49 is saved in the reproduction volume R-VOL during the recovery processing of the difference volume D-VOL.

Contrarily, to obtain a negative result in the determination at step SP83 (SP83: NO) means that the current difference volume D-VOL was created newly since the difference volume D-VOL subject to a failure was irrecoverable. Thus, the CPU 2 in this case respectively copies the bit at the far left in each CoW bitmap in the failure-situation snapshot management table 49 to the bit associated with the current snapshot generation to the portion after the bit at the far left in each CoW bitmap in the snapshot management table 48 (SP85). Accordingly, in this case, the difference data prior to the occurrence of a failure in the difference volume D-VOL will be lost.

Further, when the CPU 2 completes the processing of step SP84 or step SP85, it sets “Recovered” to the status flag in the snapshot program 40 (SP86).

The, the CPU 2 thereafter migrates the difference data saved in the reproduction volume R-VOL to the difference volume D-VOL in order from the oldest generation as of the generation of the snapshot at the time it was subject to a failure (SP87 to SP91).

Specifically, the CPU 2 confirms the generation of the snapshot at the time it was subject to a failure based on the latest snapshot generation information 52 in the snapshot program 40, and selects one block 11 (FIG. 31) in the operation volume P-VOL storing block address in the reproduction volume R-VOL for the corresponding address columns 66, 67 of a subsequent snapshot generation and an older generation in the failure-situation snapshot management table 49 (SP87). Incidentally, this selected block 11 is arbitrarily referred to as a target block 11 below, and the generation of the snapshot targeted at such time is referred to as a target snapshot generation.

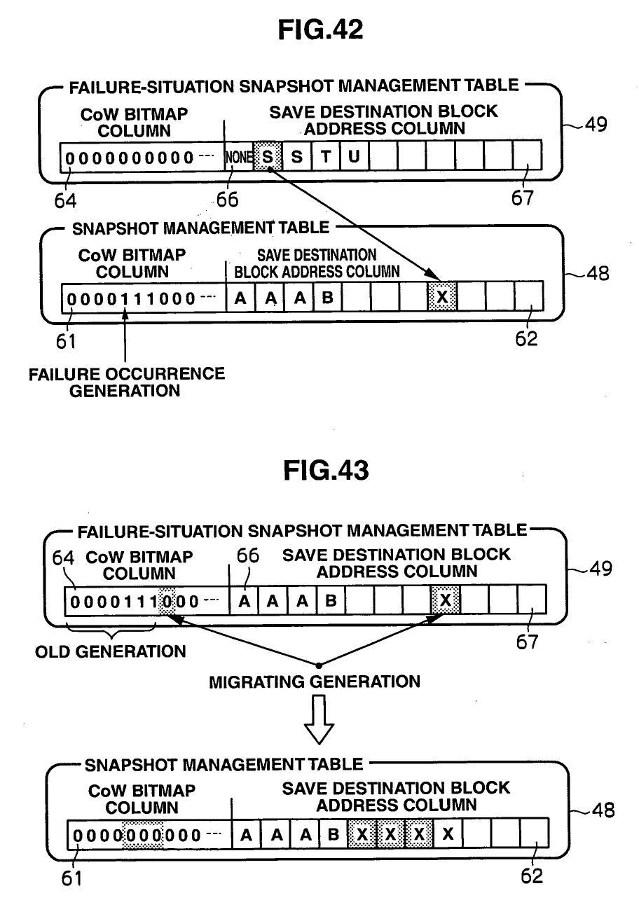

Then, the CPU 2 thereafter migrates the difference data of the target snapshot generation of this target block 11 from the reproduction volume R-VOL to the difference volume D-VOL (SP88), and then, as shown in FIG. 42, stores the block address of the block 12 (FIG. 31) in the difference volume D-VOL to which the difference data was migrated in the save destination block address column 62 corresponding to the target snapshot generation of the target block 11 in the snapshot management table 48 (SP89). Incidentally, for the convenience of explanation, FIG. 42 illustrates a case where the snapshot generations that can be managed with the snapshot management table 48 and failure-situation snapshot management table 49 are expanded to four or more generations, and the second generation in the failure-situation snapshot management table 49 corresponds to the eighth generation in the snapshot management table 48.

Further, as shown in FIG. 43, the CPU 2 updates the block addresses in the save destination block address column 62 corresponding to the target block 11 in the snapshot management table 48 and in the save destination block address column 62 of a generation to share the difference data with the target snapshot generation, and also updates the corresponding CoW bitmap in the snapshot management table 48 pursuant thereto (SP89). The snapshot generation to be targeted here is a generation before the foregoing target snapshot generation, and all generations where the value of the corresponding bit of the CoW bitmap is “1”. As the specific processing contents, a block address that is the same as the block address stored in the save destination block address column 62 of the target snapshot generation is stored in the corresponding save destination block address column 62 in the snapshot management table 48, and the value of the bit of the CoW bitmap is set to “0”.

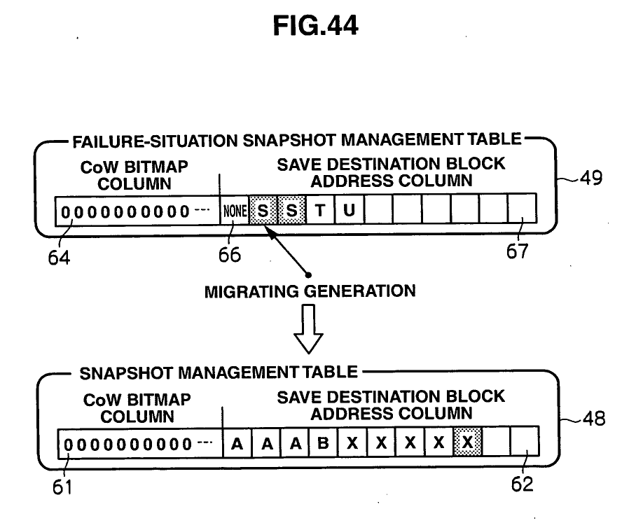

Further, as shown in FIG. 44, the CPU 2 updates the contents of the save destination block address column 62 in the snapshot management table 48 of the target block 11 of a generation that is later than the target snapshot generation and a generation sharing the same difference data with respect to the target block 11. The target generation is a generation storing the block address that is the same as the block address stored in the address columns 66, 67 of the target block 11 of the target snapshot generation regarding the target block 11 in the failure-situation snapshot management table 49. As the specific processing contents, the block address that is the same as the block address stored in the save destination block address column 62 of the target block of the target snapshot generation is stored in the save destination block address column 62 of the target block 11 of such generation in the snapshot management table 48 (SP89).

And, the CPU 2 thereafter sets “None” as the block address in the respective address columns 66, 67 in the failure-situation snapshot management table 49 corresponding to the respective save destination block address columns 62 in the snapshot management table 48 updated at step SP88 (SP90).

Next, the CPU 2 determines whether the same processing steps (step SP87 to step SP90) have been completed for all blocks in the operation volume P-VOL from which the difference volume was saved in the reproduction volume R-VOL (SP91), and returns to step SP87 upon obtaining a negative result (SP91: NO). Then, while sequentially changing the blocks 11 to be targeted, the CPU 2 repeats the same processing steps (step SP87 to step SP91) to all blocks 11 in which difference data has been saved in the reproduction volume R-VOL.

And, when the CPU 2 eventually completes the processing to all blocks 11 (SP91: YES), it sets “Normal” to the status flag 51 in the snapshot program 40 (SP92), and thereafter ends this difference data recovery processing (SP93).

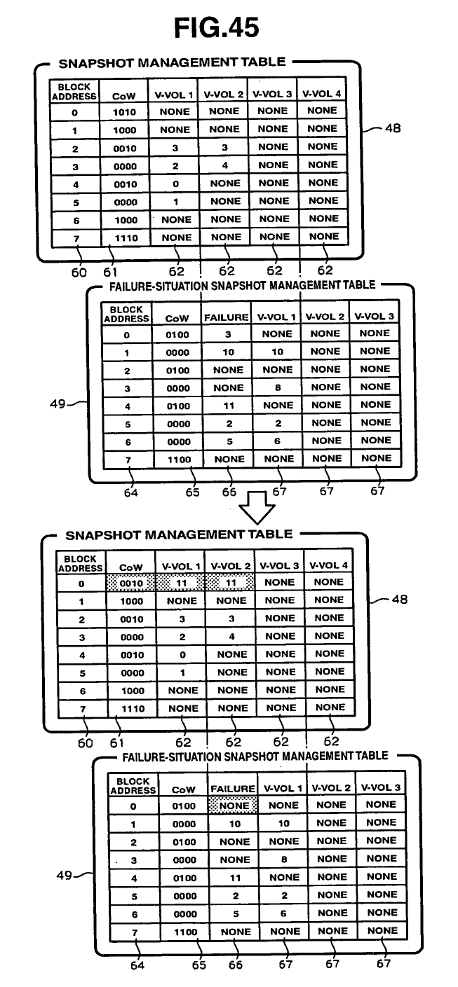

Here, the processing contents of the migration processing for migrating difference data from the reproduction volume R-VOL to the difference volume D-VOL conducted at step SP87 to step SP89 of the difference data recovery processing, and the update processing of the snapshot management table 48 and failure-situation snapshot management table 49 are explained in further detail with reference to FIG. 45 to FIG. 51. The following explanation is assuming a case where a failure occurs in the difference volume D-VOL in the second generation snapshot and a snapshot worth one generation is created after switching the operation to the reproduction volume R-VOL.

With the example shown in FIG. 45, a block address of “3” is stored in the address column 66 corresponding to the row of “Failure” in the failure-situation snapshot management table 49 regarding the blocks 11 in the operation volume P-VOL having a block address of “0” in the second generation snapshot. This means that a failure has occurred in the second generation snapshot, and that the difference data of this block 11 has been saved in a block 63 (FIG. 31) in which the block address in the reproduction volume R-VOL is “3” after the occurrence of such failure but before the creation of the third generation snapshot. Thus, the CPU 2 migrates the corresponding difference data saved in the block 63 in which the block address of the reproduction volume R-VOL is “3” to a block (a block in which the block address is “11” in this example) 12 (FIG. 31) available in the difference volume D-VOL regarding the blocks 11 having a block address of “0”.

Further, with respect to the block 11 having a block address of “0”, since the values of the respective bits corresponding to the first and second generation snapshots among the respective bits of the corresponding CoW bitmaps in the snapshot management table 49 are both “1”, it is evident these first and second generation snapshots share the same difference data. Meanwhile, since the same block address is not stored in the corresponding address column 66 of the “Failure” row and the address column 67 of the “V-VOL 1” row in the failure-situation snapshot management table 49, it is evident that the second and third generation snapshots do not share the same difference data.

Thus, the CPU 2 stores the block addresses (“11”) of the difference volume D-VOL, which is the migration destination of the difference data thereof, in the respective save destination block address columns 62 corresponding to the respective rows “V-VOL 1” and “V-VOL 2” in the snapshot management table 48. Further, the CPU 2 updates the corresponding CoW bitmap of the snapshot management table 48 to “0010”, and further sets “None” in the corresponding column 66 of the “Failure” row in the failure-situation snapshot management table 49.

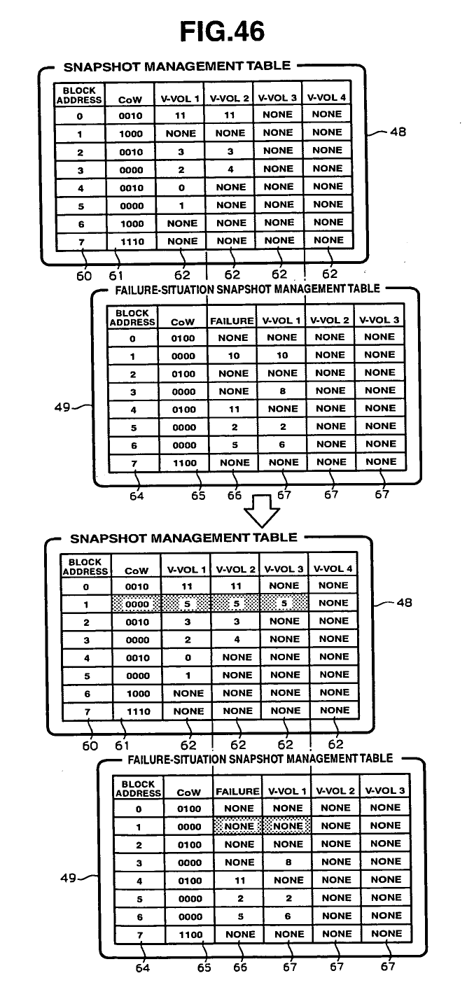

Moreover, with respect to the block 11 in the operation volume P-VOL having a block address of “1” in the second generation snapshot, as shown in FIG. 46, a block address of “10” is stored in the corresponding address column 66 of the “Failure” row in the failure-situation snapshot management table 49. Thus, with respect to this block 11, the CPU 2 migrates the corresponding difference data in the block 63 in which the block address in the reproduction volume R-VOL is “10” to the block (block in which the block address is “5”) 12 available in the difference volume D-VOL.

Further, with respect to the block 11 having a block address of “1”, since the values of the respective bits corresponding to the first and second generation snapshots among the respective bits of the corresponding CoW bitmaps in the snapshot management table 48 are both “1”, it is evident these first and second generation snapshots share the same difference data. Meanwhile, since the same block address of “10” is stored in the corresponding address column 66 of the “Failure” row and the address column 67 of the “V-VOL 1” row in the failure-situation snapshot management table 49, it is evident that the second and third generation snapshots share the same difference data.

Thus, the CPU 2 stores the block addresses (“5”) of the difference volume D-VOL, which is the migration destination of the difference data thereof, in the respective save destination block address columns 62 corresponding to the respective rows “V-VOL 1” to “V-VOL 3” in the snapshot management table 48. Further, the CPU 2 updates the corresponding CoW bitmap of the snapshot management table 48 to “0000”, and further sets “None” in each of the corresponding columns 66, 67 of the “Failure” row and “V-VOL 1” row in the failure-situation snapshot management table 49.

Meanwhile, with respect to the respective blocks 11 in the operation volume P-VOL where the block addresses are “2” and “3” in the second generation snapshot, as evident from FIG. 45, since “None” is set in the corresponding address column 66 of the “Failure” row in the failure-situation snapshot management table 49 and “3” or “4” is set in the corresponding save destination block address column 62 of the “V-VOL 2” in the snapshot management table 48, it is evident that the difference data before the occurrence of failure was saved in the difference volume D-VOL. Thus, the CPU 2 in this case does not perform any processing in relation to the respective blocks 11 where the block addresses are “2” and “3”.

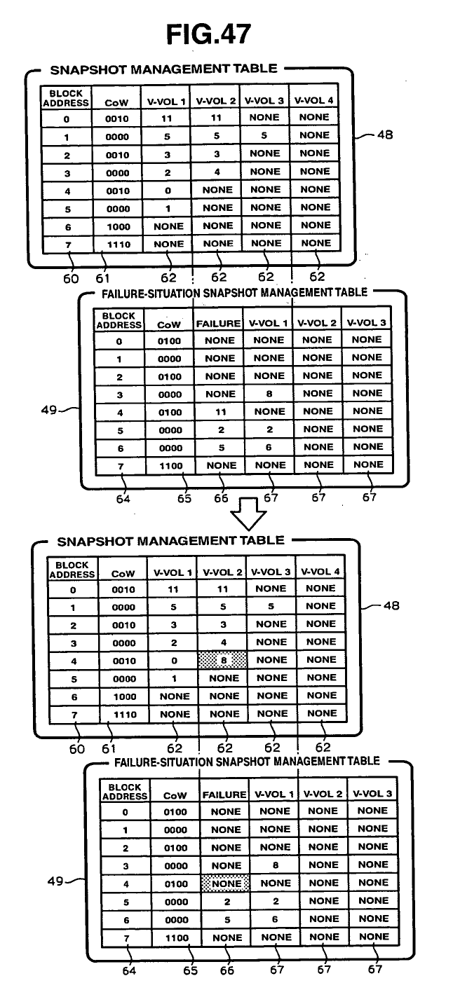

Contrarily, with respect to the block 11 in the operation volume P-VOL having a block address of “4” in the second generation snapshot, as shown in FIG. 47, a block address of “11” is stored in the corresponding address column 66 of the “Failure” row in the failure-situation snapshot management table 49. Thus, regarding this block 11, the CPU 2 migrates the corresponding difference data saved in the block 63 in which the block address of the reproduction volume R-VOL is “11” to the block (block having a block address of “8”) 12 available in the difference volume D-VOL.

Further, with respect to the block 11, since the values of the respective bits corresponding to the first and second generation snapshots among the respective bits of the corresponding CoW bitmaps in the snapshot management table 48 are both “0”, it is evident these first and second generation snapshots do not share the same difference data. Meanwhile, with respect to the block 11, since different block addresses are stored in each of the corresponding address columns 66, 67 of the “Failure” row and the “V-VOL 1” row in the failure-situation snapshot management table 49, it is evident that the second and third generation snapshots do not share the same difference data.

Thus, the CPU 2 stores the block addresses (“8”) of the difference volume D-VOL, which is the migration destination of the difference data thereof, in the respective save destination block address columns 62 corresponding to the “V-VOL 2” row in the snapshot management table 48. Further, the CPU 2 stores “None” in the corresponding address column 66 of the “Failure” row in the failure-situation snapshot management table 49.

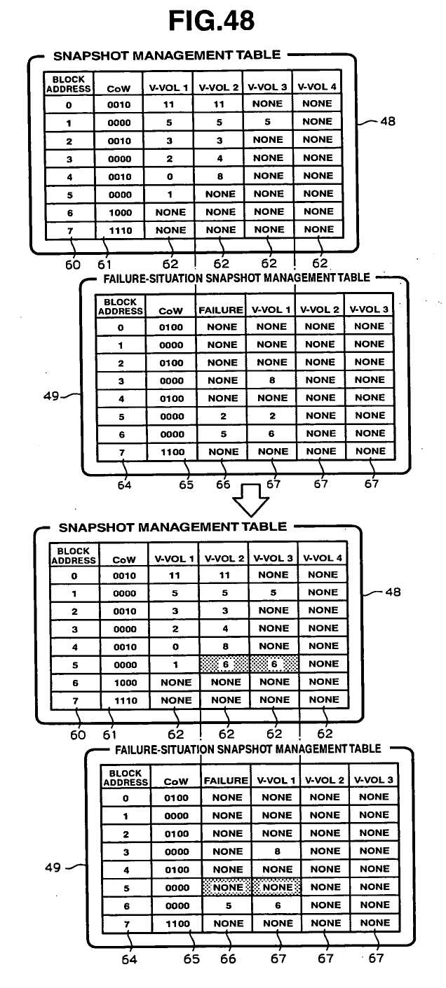

Moreover, with respect to the block 11 in the operation volume P-VOL having a block address of “5” in the second generation snapshot, as shown in FIG. 48, a block address of “2” is stored in the corresponding address column 66 of the “Failure” row in the failure-situation snapshot management table 49. Thus, with respect to this block 63, the CPU 2 migrates the corresponding difference data saved in the block 12 in which the block address in the reproduction volume R-VOL is “2” to the block (block in which the block address is “6”) 12 available in the difference volume D-VOL.

Further, with respect to the block 11, since the values of the respective bits corresponding to the first and second generation snapshots among the respective bits of the corresponding CoW bitmaps in the snapshot management table 48 are both “0”, it is evident these first and second generation snapshots do not share the same difference data. Meanwhile, with respect to this block 11, since the same block address of “2” is stored in the corresponding address column 66 of the “Failure” row and the address column 67 of the “V-VOL 1” row in the failure-situation snapshot management table 49, it is evident that the second and third generation snapshots share the same difference data.

Thus, the CPU 2 stores the block addresses (“8”) of the difference volume D-VOL, which is the migration destination of the difference data thereof, in the save destination block address columns 62 corresponding to the rows of “V-VOL 2” and “V-VOL 3” in the snapshot management table 48. Further, the CPU 2 stores “None” in the corresponding address columns 66, 67 of the respective rows of “Failure” and “V-VOL 1” in the failure-situation snapshot management table 49.

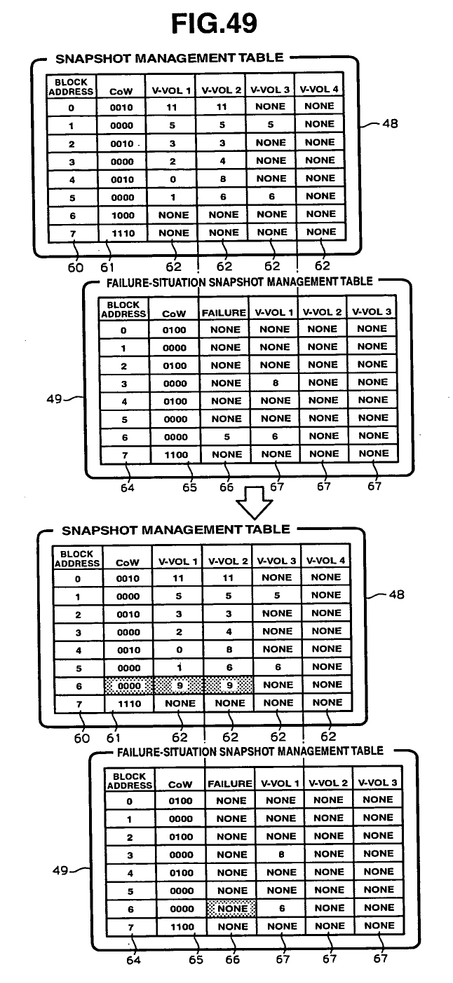

Moreover, with respect to the block 11 in the operation volume P-VOL having a block address of “6” in the second generation snapshot, as shown in FIG. 49, a block address of “5” is stored in the corresponding address column 66 of the “Failure” row in the failure-situation snapshot management table 49. Thus, with respect to this block 11, the CPU 2 migrates the corresponding difference data saved in the block 63 in which the block address in the reproduction volume R-VOL is “5” to the block (block in which the block address is “9”) 12 available in the difference volume D-VOL. Further, with respect to the block 11, since the value of the bit corresponding to the first generation snapshot among the respective bits of the corresponding CoW bitmaps in the snapshot management table 48 is “1”, it is evident these first and second generation snapshots share the same difference data. Meanwhile, since different block addresses are stored in the corresponding address column 66 of the “Failure” row and the corresponding address column 67 of the “V-VOL 1” row in the failure-situation snapshot management table 49, it is evident that the second and third generation snapshots do not share the same difference data.

Thus, the CPU 2 stores the block addresses (“9”) of the difference volume D-VOL, which is the migration destination of the difference data thereof, in the save destination block address columns 62 corresponding to the rows of “V-VOL 1” and “V-VOL 2” in the snapshot management table 48. Further, the CPU 2 updates the corresponding CoW bitmap of the snapshot management table 48 to “0000”, and further stores “None” in the corresponding address column 66 of the “Failure” row in the failure-situation snapshot management table 49. Moreover, with respect to the block 11 in the operation volume P-VOL having a block address of “7” in the second generation snapshot, as shown in FIG. 45, since “None” is stored in the corresponding address column 66 of the “Failure” row in the failure-situation snapshot management table 49, and “None” is stored in the corresponding save destination block address column 62 of the “V-VOL 2” row in the snapshot management table 48, it is evident that the writing of user data is yet to be performed in the block 11. Thus, the CPU 2 in this case does not perform any processing in relation to the respective blocks 11 where the block address is “7”.

Meanwhile, with respect to the block 11 in the operation volume P-VOL having a block address of “0” to “2” in the third generation snapshot, as shown in FIG. 45, “None” is stored in the corresponding address column 67 of the “V-VOL 1” row in the failure-situation snapshot management table 49. Thus, it is evident that the saving of difference data from the block 11 has not yet been performed in the third generation snapshot. Thus, the CPU 2 in this case does not perform any processing in relation to the respective blocks 11 where the block addresses are “0” to “2”.

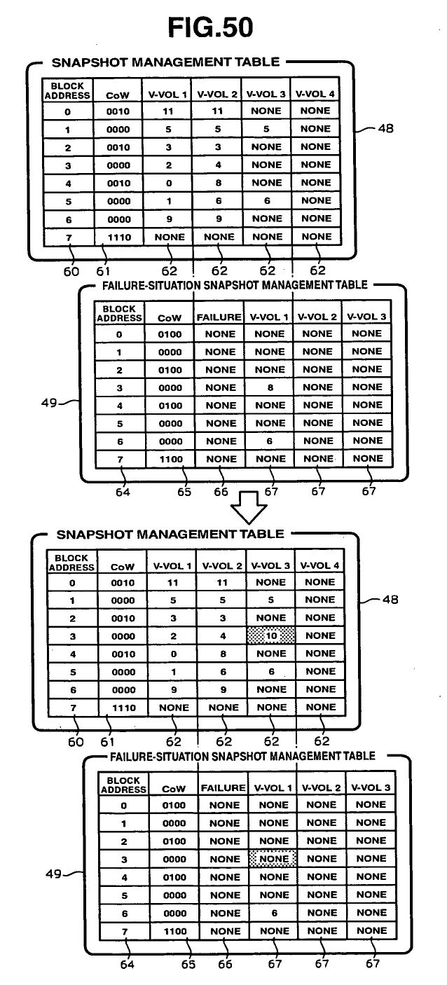

Contrarily, with respect to the block 11 in the operation volume P-VOL having a block address of “3” in the third generation snapshot, as shown in FIG. 50, a block address of “8” is stored in the corresponding address column 67 of the “V-VOL 1” row in the failure-situation snapshot management table 49. Thus, with respect to this block 11, the CPU 2 migrates the corresponding difference data saved in the block 63 in which the block address in the reproduction volume R-VOL is “8” to the block (block in which the block address is “10”) 12 available in the difference volume D-VOL.

Further, with respect to this block 11, it is evident that it shares the difference data with the snapshot of a generation before the occurrence of the failure as described above, and that it also shares the difference data with the snapshot of subsequent generations from each of the corresponding address columns 67 of the respective rows of “V-VOL 1” and “V-VOL 2” in the failure-situation snapshot management table 49.

Thus, the CPU 2 stores the block addresses (“10”) of the difference volume D-VOL, which is the migration destination of the difference data thereof, in the save destination block address column 62 corresponding to the “V-VOL 3” in the snapshot management table 48. Further, the CPU 2 sets “None” in the corresponding column 67 of the “V-VOL 1” row in the failure-situation snapshot management table 49.

Meanwhile, with respect to the respective blocks 11 in the operation volume P-VOL where the block addresses are “4” and “5” in the third generation snapshot, as evident from FIG. 45, since “None” is set in the corresponding address column 67 of the respective “V-VOL 1” rows in the failure-situation snapshot management table 49. Accordingly, it is evident that the difference data from the block 11 has not yet been saved in the third generation snapshot. Thus, the CPU 2 in this case does not perform any processing in relation to the respective blocks 11 where the block addresses are “4” and “5”.

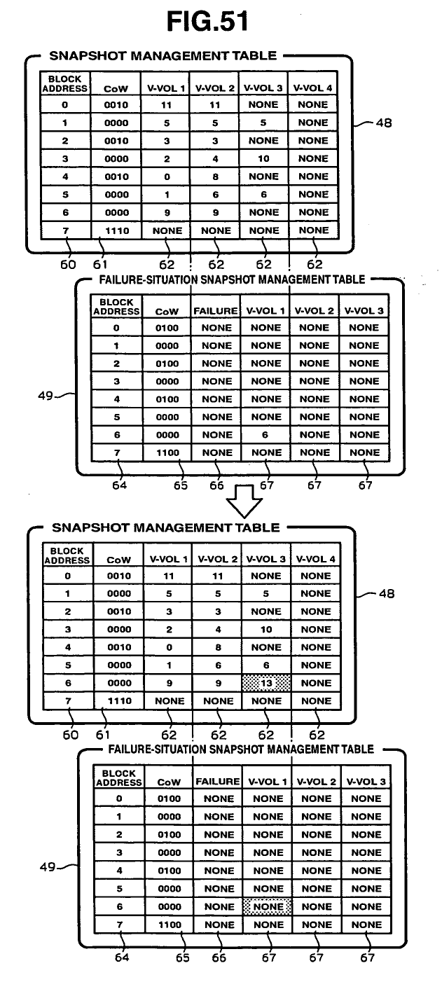

Meanwhile, with respect to the block 11 in the operation volume P-VOL having a block address of “6” in the third generation snapshot, as shown in FIG. 51, “6” is set in the corresponding address column 67 of the “V-VOL 1” row in the failure-situation snapshot management table 49. Thus, with respect to this block 11, the CPU 2 migrates the corresponding difference data saved in the block 63 in which the block address in the reproduction volume R-VOL is “6” to the block (block in which the block address is “13”) 12 available in the difference volume D-VOL.

Further, with respect to this block 11, it is evident that it does not share the difference data with the snapshot of a generation before the occurrence of the failure as described above, and that it also does not share the difference data with the snapshot of subsequent generations from each of the corresponding address columns 67 of the respective rows of “V-VOL 1” and “V-VOL 2” in the failure-situation snapshot management table 49.

Thus, the CPU 2 stores the block addresses (“13”) of the difference volume D-VOL, which is the migration destination of the difference data thereof, in the save destination block address column 62 corresponding to the “V-VOL 3” in the snapshot management table 48. Further, the CPU 2 sets “None” in the corresponding column 67 of the “V-VOL 1” row in the failure-situation snapshot management table 49.

Meanwhile, with respect to the respective blocks 11 in the operation volume P-VOL where the block address is “7” in the third generation snapshot, as evident from FIG. 45, “None” is set in the corresponding address column 67 of the respective “V-VOL1” rows in the failure-situation snapshot management table 49. Accordingly, it is evident that the difference data from the block 11 has not yet been saved in the third generation snapshot. Thus, the CPU 2 in this case does not perform any processing in relation to the block 11 in which the block address of the third generation snapshot is “7”.

As a result of the series of processing described below, the difference data saved in the reproduction volume R-VOL can be migrated to the difference volume D-VOL while retaining the consistency of the snapshot management table 48 and failure-situation snapshot management table 49.

Further, according to this kind of snapshot maintenance method, even when a failure occurs in the difference volume D-VOL during the creation of a snapshot, the new difference data created based on the write processing of user data to the operation volume P-VOL until the difference volume D-VOL is recovered can be retained in the reproduction volume R-VOL, and the difference data can thereafter be migrated to the difference volume D-VOL at the stage when the failure in the difference volume D-VOL is recovered. Further, even with respect to the snapshot management table 48, inconsistencies until the failure in the difference volume D-VOL is recovered can be corrected with the failure-situation snapshot management table 49.

Therefore, according to this snapshot maintenance method, even when a failure occurs in the difference volume D-VOL, since a part or the whole of the snapshots created theretofore can be maintained while performing the ongoing operation, the reliability of the overall disk array device can be improved dramatically.

### (3) Other Embodiments

In the embodiment described above, although a case of employing the present invention in the NAS unit 33 (FIG. 29) of the disk array device 23 (FIG. 29) was explained, the present invention is not limited thereto, and, for instance, may also be widely employed in a NAS device to be formed separately from the disk array device 23 as well as various devices that provide a snapshot function.

Further, in the embodiments described above, although a case of respectively configuring the snapshot management table 48 as the first difference data management information and the failure-situation snapshot management table 49 as the snapshot management table 48 as shown in FIG. 31 was explained, the present invention is not limited thereto, and various other modes may be widely adopted as the mode of such first and second difference data management information.

In addition to the application in a disk array device, the present invention may also be widely employed in a NAS device or the like.

I(We) claim:

1. A snapshot maintenance apparatus for maintaining an image at the time of creating a snapshot of an operation volume for reading and writing data from and to a host system, comprising:
a volume setting unit for setting a difference volume and a failure-situation volume in a connected physical device; and
a snapshot management unit for sequentially saving difference data, which is the difference formed from said operation volume at the time of creating said snapshot and the current operation volume, in said difference volume according to the writing of said data from said host system in said operation volume, and saving said difference data in said failure-situation volume when a failure occurs in said difference volume.

2. The snapshot maintenance apparatus according to claim 1, wherein said snapshot management unit creates first difference data management information formed from management information of said difference data in said difference volume and second difference data management information formed from management information of said difference data in said failure-situation volume, and migrates said difference data saved in said failure-situation volume to said difference volume while maintaining the consistency of said first and second difference data management information.

3. The snapshot maintenance apparatus according to claim 2, wherein said snapshot management unit determines whether the failure of said difference volume is recoverable or irrecoverable based on the mean time to repair relating to the failure of said difference volume, and sets a new difference volume and migrates said difference data saved in said failure-situation volume to said new difference volume when it is determined that the failure of the difference volume is irrecoverable.

4. The snapshot maintenance apparatus according to claim 2, wherein said snapshot management unit manages a plurality of generations of said snapshots based on said first and second difference data management information.

5. The snapshot maintenance apparatus according to claim 2, wherein first and second difference data management information includes bit information for managing the saving status of said difference data per prescribed block configuring said operation volume, and
wherein said snapshot management unit copies the corresponding region of said second difference data management information to the corresponding position of said first difference data management information before migrating said difference data saved in said failure-situation volume to said original difference volume or said new difference volume.

6. The snapshot maintenance apparatus according to claim 2, wherein said snapshot management unit stores said bit information of said snapshot at the time a failure occurs in said difference volume, and determines whether the failure of said original difference volume has recovered or said new difference volume has been created based on said first difference data management information of said original difference volume or said new difference volume upon migrating said difference data saved in said failure-situation volume to said original difference volume or said new difference volume.

7. The snapshot maintenance apparatus according to claim 1, wherein said snapshot management unit stores the status of said difference volume relating to the failure status, and saves said difference data in one of the corresponding said difference volume or said failure-situation volume based on the status of said stored difference volume.

8. The snapshot maintenance apparatus according to claim 1, wherein said failure-situation volume is set in a storage area provided by a physical device having higher reliability than said difference volume.

9. A snapshot maintenance method for maintaining an image at the time of creating a snapshot of an operation volume for reading and writing data from and to a host system, comprising:
a first step of setting a difference volume and a failure-situation volume in a connected physical device; and
a second step of sequentially saving difference data, which is the difference formed from said operation volume at the time of creating said snapshot and the current operation volume, in said difference volume according to the writing of said data from said host system in said operation volume, and saving said difference data in said failure-situation volume when a failure occurs in said difference volume.

10. The snapshot maintenance method according to claim 2, wherein at said second step, first difference data management information formed from management information of said difference data in said difference volume and second difference data management information formed from management information of said difference data in said failure-situation volume is created, and said difference data saved in said failure-situation volume is migrated to said original difference volume or said new difference volume while maintaining the consistency of said first and second difference data management information after the failure of said original difference volume has recovered or said new difference volume is set.

11. The snapshot maintenance method according to claim 10, wherein at said second step, whether the failure of said difference volume is recoverable or irrecoverable is determined based on the mean time to repair relating to the failure of said difference volume, said new difference volume when it is determined that the failure of the difference volume is irrecoverable, and said difference data saved in said failure-situation volume is migrated to said new difference volume.

12. The snapshot maintenance method according to claim 10, wherein at said second step, a plurality of generations of said snapshots are managed based on said first and second difference data management information.

13. The snapshot maintenance method according to claim 10, wherein said first and second difference data management information includes bit information for managing the saving status of said difference data per prescribed block configuring said operation volume, and, at said second step, the corresponding region of said second difference data management information is copied to the corresponding position of said first difference data management information before migrating said difference data saved in said failure-situation volume to said original difference volume or said new difference volume.

14. The snapshot maintenance method according to claim 10, wherein at said second step, said bit information of said snapshot is stored at the time a failure occurs in said difference volume, and whether the failure of said original difference volume has recovered or said new difference volume has been created is determined based on said first difference data management information of said original difference volume or said new difference volume upon migrating said difference data saved in said failure-situation volume to said original difference volume or said new difference volume.

15. The snapshot maintenance method according to claim 9, wherein at said second step, the status of said difference volume relating to the failure status is stored, and said difference data is saved in one of the corresponding said difference volume or said failure-situation volume based on the status of said stored difference volume.

16. The snapshot maintenance method according to claim 9, wherein said failure-situation volume is set in a storage area provided by a physical device having higher reliability than said difference volume.
